(19) United States
(12) Patent Application Publication
(10) Pub. No.: US 2011/0137727 A1
(43) Pub. Date: Jun. 9, 2011

(54) SYSTEMS AND METHODS FOR DETERMINING PROXIMITY OF MEDIA OBJECTS IN A 3D MEDIA ENVIRONMENT

(75) Inventors: David Chung, Santa Clara, CA (US); Walter Richard Klappert, Los Angeles, CA (US)

(73) Assignee: Rovi Technologies Corporation, Santa Clara, CA (US)

(21) Appl. No.: 12/632,489

(22) Filed: Dec. 7, 2009

(51) Int. Cl. G06Q 30/00; H04N 13/04; H04N 5/445; G06Q 50/00; A63F 9/24; G06F 15/16

(52) U.S. Cl. 705/14.55; 348/51; 705/14.49; 705/14.7; 725/38; 463/1; 709/206

(57) ABSTRACT

Systems and methods for determining proximity of objects in a three-dimensional (3D) media guidance application are provided. A first rank may be associated with a first media object. A second rank lower than the first rank may be associated with a second media object. The first and second media objects may appear at respective first and second distances in 3D space when viewed using a stereoscopic optical device. The first and second distances may correspond respectively to the first and second ranks of the first and second media objects. The first and second ranks may be automatically associated with the first and second media objects using predetermined or viewer-defined criteria. A viewer may input ranking criteria using a user input device having an accelerometer.

### BACKGROUND OF THE INVENTION

Traditional systems provide three-dimensional (3D, or stereoscopic) media environments and present media objects in different planes parallel to a display screen. In these systems, certain media objects in the display screen may appear closer to a viewer than other media objects. The traditional systems do not use predetermined criteria or rankings to determine the relative distances at which media objects should appear from each other and from the viewer. These traditional systems for displaying media objects therefore lack the means to effectively focus the viewer's attention on the most important or relevant media objects in the display.

### SUMMARY OF THE INVENTION

In view of the foregoing, systems and methods for determining proximity of media objects in a 3D media environment in accordance with various embodiments of the present invention are provided. In particular, media objects may appear to be positioned in a display screen at different distances from a viewer. In some embodiments, each media object may be associated with a rank. The distance a media object appears from a viewer may be related to the rank associated with the media object.

In some embodiments, a first rank may be associated with a first media object, and a second rank lower than the first rank may be associated with a second media object. Since the first media object is ranked higher than the second media object, the first media object may appear closer to the viewer than the second media object.

In some embodiments, the stereoscopic media environment may be a stereoscopic media guidance application. The stereoscopic media guidance application may display media objects representing media listings of available content. In some embodiments, the ranking criteria for media objects may be automatically determined by the media guidance application. In one embodiment, the media guidance application may automatically associate media objects with ranks based on viewer preferences. In some implementations, the viewer may have a preference for medical dramas media assets over comedies media assets. Accordingly, a media object corresponding to the media asset “House” may be associated with a higher rank than a rank associated with a media object corresponding to the media asset “Friends”. In some implementations, the media object corresponding to the media asset “House” may appear closer to the viewer than the media object corresponding to the media asset “Friends” in the stereoscopic media guidance application display.

In other embodiments, the viewer may specify ranking criteria for media objects. In one implementation, the viewer may indicate a desire to rank media objects based on the represented media listings' popularity among other viewers. Media objects representing shows with high viewer ratings may be associated with higher ranks than media objects representing shows with low viewer ratings.

In some embodiments, advertisements may appear in a stereoscopic media environment, such as a stereoscopic media guidance application. Each advertisement may have an associated sponsor. In some embodiments, first and second advertisements may be associated with respective first and second ranks based on the amount of the monetary contribution made by each associated sponsor. The sponsor associated with the first advertisement may have made a higher monetary contribution than the sponsor associated with the second advertisement, so the first advertisement may be associated with a higher rank than the second advertisement. The first advertisement may appear closer to the viewer than the second advertisement in the stereoscopic media environment. In some embodiments, advertisements may include objects displayed in a scene of a video, banner displays, and/or small or large scale video displays of advertisements.

In some embodiments, media objects may appear in a stereoscopic media environment, such as a movie scene, as part of various sponsors' product placement campaigns. Media objects associated with sponsors who made higher monetary contributions may be associated with higher ranks than media objects associated with sponsors who made lower monetary contributions. Higher ranked media objects may appear closer to the viewer than lower ranked media objects in the stereoscopic media environment. In some embodiments, displayed media objects may be selectable. A viewer selection of a particular media object may cause more information about a product represented by the media object, an automatic purchase of the product represented by the media object, or information about the sponsor associated with the media object to be displayed.

In some embodiments, the stereoscopic media environment may be a videogame environment. Media objects may represent collectible objects that an avatar in the videogame may collect. Different collectible objects may have different associated ranks based on usefulness of the collectible objects to the avatar. The usefulness of the collectible objects, and hence the associated ranks, may vary based on the situation in the videogame environment. In one embodiment, the videogame may be a combat videogame. A first collectible object may represent a weapon, and a second collectible object may represent medical supplies. If the avatar is about to fight a battle but does not have any weapons, the first collectible object may be associated with a higher rank than the second collectible object since obtaining a weapon is of primary importance for the avatar. The first collectible object may appear closer to the viewer than the second collectible object in the stereoscopic videogame environment. If the avatar is badly injured, the second collectible object may be associated with a higher rank than the first collectible object since restoring health is of primary importance for the avatar. The second collectible object may appear closer to the viewer than the first collectible object in the stereoscopic videogame environment.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5A shows an illustrative stereoscopic optical device in accordance with an embodiment of the invention;

FIG. 5B shows an illustrative stereoscopic optical device in accordance with another embodiment of the invention;

FIG. 5C shows an illustrative stereoscopic optical device in accordance with a third embodiment of the invention;

FIG. 6A shows an illustrative front view of a display screen of media objects appearing in different planes in accordance with an embodiment of the invention;

FIG. 6B shows an illustrative side view of the display screen illustrated in FIG. 6A, assuming the media objects are actually three-dimensional, in accordance with an embodiment of the invention;

FIG. 7A shows an illustrative display screen of selectable media guidance objects displayed in different planes in accordance with an embodiment of the invention;

FIG. 7B shows an illustrative display screen of movie representations displayed in different planes in accordance with an embodiment of the invention;

FIG. 8 shows an illustrative arrangement of user equipment devices and peripheral devices in accordance with an embodiment of the invention;

FIGS. 9A-B show illustrative configurations of additional information about a selected media object on a display screen in accordance with various embodiments of the invention;

FIG. 10 shows an illustrative display screen of recommended media content representations displayed in different planes in accordance with an embodiment of the invention;

FIG. 11 shows an illustrative configuration of additional information about a selected advertisement on a display screen in accordance with an embodiment of the invention;

FIGS. 12A-D show illustrative configurations for visually distinguishing a media object on a display screen in accordance with various embodiments of the invention;

FIG. 13A shows an illustrative display screen of a stereoscopic videogame environment in accordance with an embodiment of the invention;

FIG. 13B shows an illustrative display screen of a stereoscopic videogame environment in accordance with another embodiment of the invention;

FIGS. 14A-C show various illustrative rankings of media objects in accordance with various embodiments of the invention;

FIG. 15 shows an illustrative scene from a stereoscopic media asset in accordance with an embodiment of the invention;

FIG. 16 shows an illustrative display screen of a stereoscopic chat room environment in accordance with an embodiment of the invention;

FIG. 17 shows an illustrative display screen of a stereoscopic e-mail client environment in accordance with an embodiment of the invention;

FIG. 18 shows an illustrative display screen of a stereoscopic survey environment in accordance with an embodiment of the invention;

FIG. 19 shows an illustrative display screen of credits for a stereoscopic media asset in accordance with an embodiment of the invention;

FIG. 20 shows an illustrative display screen of reminders for media assets in a stereoscopic media environment in accordance with an embodiment of the invention;

FIG. 21 is an illustrative flow diagram for relating ranks and prominence of media objects in a stereoscopic media environment in accordance with an embodiment of the invention;

FIG. 22 is an illustrative flow diagram for relating sponsor contributions, ranks, and prominence of advertisements in accordance with an embodiment of the invention;

FIG. 23 is an illustrative flow diagram for creating a list of media objects of a particular type in accordance with an embodiment of the invention;

FIG. 24 is an illustrative flow diagram for creating a ranked list of media objects of a particular type in accordance with an embodiment of the invention; and

FIG. 25 is an illustrative flow diagram for associating media objects with respective apparent distances based on rank in accordance with an embodiment of the invention.

### DETAILED DESCRIPTION OF EMBODIMENTS

This invention generally relates to determining the proximity of media objects to a viewer in a stereoscopic, or 3D, media environment. In particular, each media object of a plurality may have a respective associated rank. A media object whose associated rank is higher than those of other media objects may appear closer to a viewer than other media objects. More specifically, media objects with higher ranks may appear more in focus than media objects with lower ranks. Media objects may include media listings, recommendations, collectible objects and locations in a videogame, warnings, instructions, scene objects, messages, regions for viewer input, text objects, icons, images, reminders, and advertisements.

As defined herein, an asset or media asset refers to any type of media (or data file) that may be played, accessed, recorded and/or viewed. As referred to herein, the term “focus” or being into focus should be understood to mean to change the appearance of a displayed item or object to make the item or object more visually prominent than other items or objects.

The amount of media available to viewers in any given media delivery system can be substantial. Consequently, many viewers desire a form of media guidance through an interface that allows viewers to efficiently navigate media selections and easily identify media that are they may find important or desirable. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow viewers to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow viewers to navigate among and locate content related to the video content including, for example, video clips, articles, advertisements, chat sessions, games, etc. Guidance applications also allow viewers to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, viewers are accessing media on personal computers (PCs) and other devices on which they traditionally did not, such as hand-held computers, personal digital assistants (PDAs), mobile telephones, or other mobile devices. On these devices viewers are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as online applications (i.e., provided on a web-site), or as stand-alone applications or clients on hand-held computers, PDAs, mobile telephones, or other mobile devices. The various devices and platforms that may implement media guidance applications are described in more detail below.

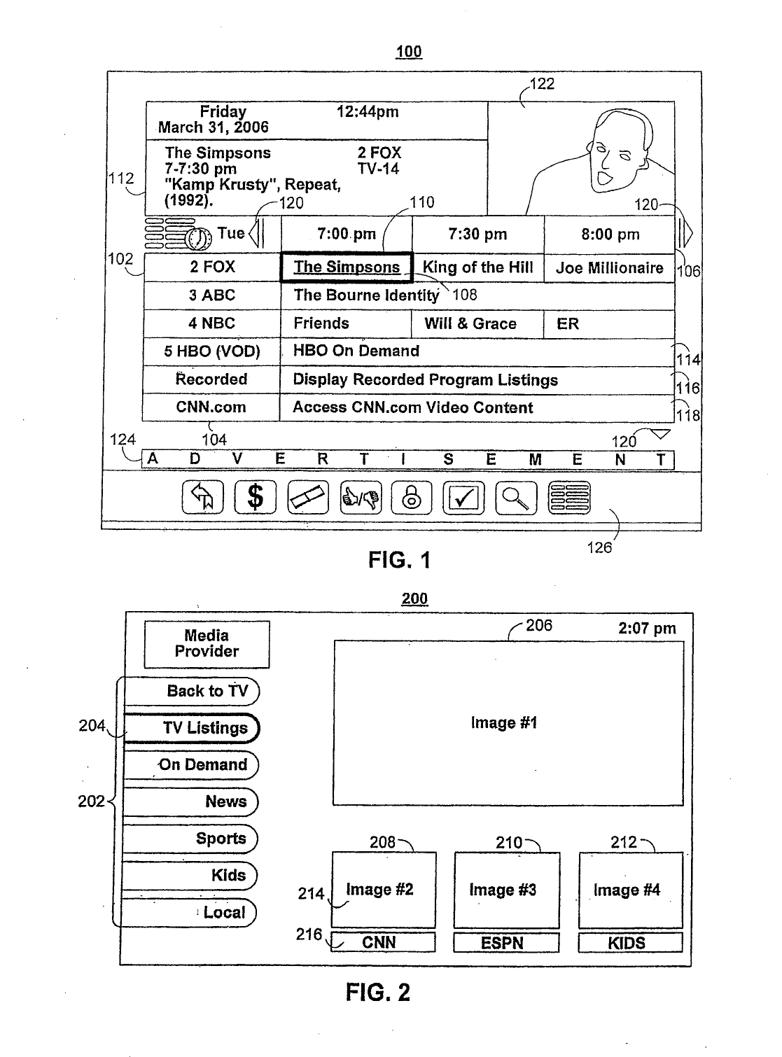

One of the functions of the media guidance application is to provide media listings and media information to viewers. FIGS. 1-2 show illustrative display screens that may be used to provide media guidance, and in particular media listings. The display screens shown in FIGS. 1-2, 7A-B, 10, and 12A-D may be implemented on any suitable device or platform. While the displays of FIGS. 1-2, 7A-B, 10, and 12A-D are illustrated as full screen displays, they may also be fully or partially overlaid over media content being displayed. A viewer may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the viewer's indication, the media guidance application may provide a display screen with media information organized in one of several ways, such as by time and channel in a grid, by time, by channel, by media type, by category (e.g., movies, sports, news, children, or other categories of programming), or other predefined, viewer-defined, or other organization criteria. In some embodiments, media information may be organized by predefined or viewer-defined rankings.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a viewer can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information. In some embodiments, meta data associated with one or more program listings may be displayed in region 112 or in some other suitable region of display 100. In some embodiments, the meta data may be displayed more prominently than other elements in display 100. For example, the meta data may appear closer to the viewer than channel/media type identifiers 104. In some embodiments, a broadcaster's logo may be included in meta data or other information related to a program listing. The broadcaster's logo may appear closer to the viewer than other related data or other elements in display 100.

In some embodiments, some or all parts of the walls of grid 102 may be displayed more prominently than other elements in display 100. For example, the walls around certain cells, such as the cell including program listing 108, in grid 102 may appear closer to the viewer than the walls around other cells in grid 102. Alternately, all parts of the walls of grid 102 may appear closer to the viewer than, for example, program information region 112.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on viewer selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the viewer selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the viewer to view and/or preview programs that are currently available, will be available, or were available to the viewer. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a viewer's profile/preferences, monitored viewer activity, the type of display provided, or on other suitable targeted advertisement bases. Advertisement 124 may have an associated rank based on a viewer's profile/preferences, monitored viewer activity, the type of display provided, or other suitable predefined or viewer-defined ranking bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content.

The rank associated with advertisement 124 may be related to the size, shape, location, and appearance of advertisement 124 in a guidance application display. For example, if advertisement 124 is associated with a high rank, advertisement 124 may occupy a larger area in display 100 or be displayed with scrolling text to attract the viewer's attention. If a second advertisement associated with a lower rank than advertisement 124 is displayed in display 100, the second advertisement may be smaller than advertisement 124 or appear in a less prominent location in display 100.

Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the viewer to access different types of media content, media guidance application displays, and/or media guidance application features. Options region 126 may be part of display 100 (and other display screens of the present invention), or may be invoked by a viewer by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, ranking a program, or other features. Options available from a main menu display may include search options, VOD options, parental control options, access to various types of listing displays, subscribe to a premium service, edit a viewer's profile, access a browse overlay, edit ranking criteria, or other options.

The media guidance application may be personalized based on a viewer's preferences. A personalized media guidance application allows a viewer to customize displays and features to create a personalized “experience” with the media guidance application. This personalized experience may be created by allowing a viewer to input these customizations and/or by the media guidance application monitoring viewer activity to determine various viewer preferences. Viewers may access their personalized guidance application by logging in or otherwise identifying themselves to the guidance application. Customization of the media guidance application may be made in accordance with a viewer profile. The customizations may include varying presentation schemes (e.g., color scheme of displays, font size of text, etc.), aspects of media content listings displayed (e.g., only HDTV programming, viewer-specified broadcast channels based on favorite channel selections, re-ordering the display of channels, recommended media content, etc.), desired recording features (e.g., recording or series recordings for particular viewers, recording quality, etc.), parental control settings, ranking criteria, and other desired customizations.

The media guidance application may allow a viewer to provide viewer profile information or may automatically compile viewer profile information. The media guidance application may, for example, monitor the media the viewer accesses and/or other interactions the viewer may have with the guidance application. Additionally, the media guidance application may obtain all or part of other viewer profiles that are related to a particular viewer (e.g., from other web sites on the Internet the viewer accesses, such as www.tvguide.com, from other media guidance applications the viewer accesses, from other interactive applications the viewer accesses, from a handheld device of the viewer, etc.), and/or obtain information about the viewer from other sources that the media guidance application may access. As a result, a viewer can be provided with a unified guidance application experience across the viewer's different devices. This type of viewer experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a viewer the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the viewer or to emphasize certain content, as desired by the media provider or based on rankings or viewer preferences. Various systems and methods for graphically accentuating media listings are discussed in, for example, Yates, U.S. patent application Ser. No. 11/324,202, filed Dec. 29, 2005, which is hereby incorporated by reference herein in its entirety.

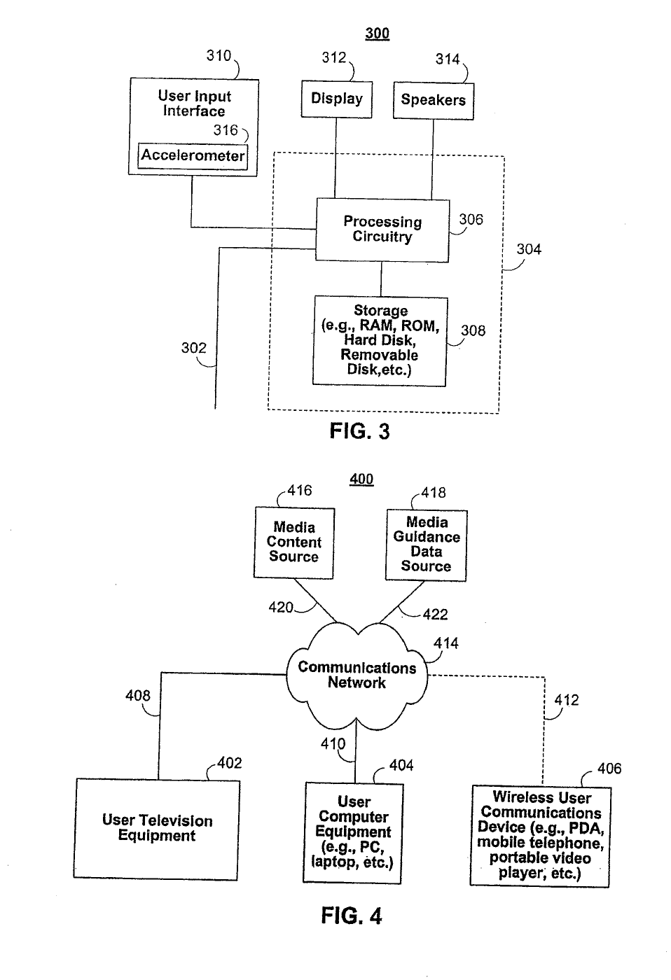

Viewers may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, viewer preferences or profile information, ranking information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A viewer may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. In some embodiments, the user input interface 310 may contain an accelerometer 316. When the viewer moves the user input interface 310 containing the accelerometer 316, the accelerometer 316 may transmit information about the user input interface's motion and orientation to the user equipment device 300. In some embodiments, the user input interface 310 may include a gyroscope (not shown) in addition to or instead of accelerometer 316.

For example, the user input interface 310 containing the accelerometer 316 may be a wand-like device, similar to the user input interface used in the Nintendo Wii. In one embodiment, the wand-like device may be in the shape of a rectangular prism. In other embodiments, the wand-like device may be in the shape of a triangular prism, sphere, or cylinder, or the wand-like device may narrow gradually from one end to the other, like a pyramid or cone. If the viewer holds the wand-like device and swings his arm up, the accelerometer 316 may transmit information indicating an upward motion and an upward orientation of the point on the wand-like device farthest away from the viewer. If the viewer holds the wand-like device and swings his arm down, the accelerometer 316 may transmit information indicating a downward motion and a downward orientation of the point on the wand-like device farthest away from the viewer. If the viewer holds the wand-like device and swings his arm parallel to the ground, the accelerometer 316 may transmit information indicating a lateral motion and an orientation of the wand-like device parallel to the ground. The viewer may move and change the orientation of the wand-like device in any combination of upward, downward, and lateral arm motions. The viewer may also move and change the orientation of the wand-like device by moving only his wrist and not his entire arm, such as by rotating his wrist up and down, side to side, or in a circular motion while holding the wand-like device.

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each viewer may utilize more than one type of user equipment device (e.g., a viewer may have a television set and a computer) and also more than one of each type of user equipment device (e.g., a viewer may have a PDA and a mobile telephone and/or multiple television sets).

The viewer may also set various settings to maintain consistent media guidance application settings across in-home devices and remote devices. Settings include those described herein, as well as channel and program favorites, programming preferences that the guidance application utilizes to make programming recommendations, display preferences, media asset ranking criteria, and other desirable guidance settings. For example, if a viewer sets a channel as a favorite on, for example, the web site www.tvguide.com on their personal computer at their office, the same channel would appear as a favorite on the viewer's in-home devices (e.g., user television equipment and user computer equipment) as well as the viewer's mobile devices, if desired. Therefore, changes made on one user equipment device can change the guidance experience on another user equipment device, regardless of whether they are the same or a different type of user equipment device. In addition, the changes made may be based on settings input by a viewer, as well as viewer activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a viewer), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a viewer to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a viewer-specified period of time, a system-specified period of time, in response to a request from user equipment, etc.). In some approaches, guidance data from media guidance data source 418 may be provided to viewers' equipment using a client-server approach. For example, a guidance application client residing on the viewer's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for viewers to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a viewer may transmit media content from user computer equipment to a portable video player or portable music player.

In a second approach, viewers may have multiple types of user equipment by which they access media content and obtain media guidance. For example, some viewers may have home networks that are accessed by in-home and mobile devices. Viewers may control in-home devices via a media guidance application implemented on a remote device. For example, viewers may access an online media guidance application on a website via a personal computer at their office, or a mobile device such as a PDA or web-enabled mobile telephone. The viewer may set various settings (e.g., recordings, reminders, ranking criteria, or other settings) on the online guidance application to control the viewer's in-home equipment. The online guide may control the viewer's equipment directly, or by communicating with a media guidance application on the viewer's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, viewers of user equipment devices inside and outside a home can use their media guidance application to communicate directly with media content source 416 to access media content. Specifically, within a home, viewers of user television equipment 404 and user computer equipment 406 may access the media guidance application to navigate among and locate desirable media content. Viewers may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

In some embodiments, media guidance application objects or media guidance objects may appear to be displayed in different planes. In particular, one of the media guidance objects may be displayed in a first plane (e.g., the media guidance object appears flat on the screen) and other media guidance objects may be displayed in a second plane (e.g., the media guidance objects appear as though they are in front of the screen or behind the screen).

As defined herein, the term media guidance object or media guidance application object means any website, live video feed, or recorded video feed playback or visual representation of media guidance application data such as a visual representation of a viewer profile, a media asset, previously recorded media asset, media asset recommendation, email message, notification, reminder, scheduled recording, favorite channel, photograph, icon, sketch, Short Message Service (SMS) message, Multimedia Messaging Service (MMS) message, service provider message, new media asset release, media category, a queue that includes media assets to be viewed at a future time, a playlist of media assets, or home video, or any combination of the same.

In a stereoscopic media guidance application, or any other stereoscopic media environment, the stereoscopic effect may be achieved by generating a first image to be viewed with a viewer's right eye and generating a second image to be viewed with the viewer's left eye. The first and second images may be generated by processing circuitry 306 and may each include a copy of a media object. The copy of the media object in the second image may be a translation by a certain distance of the copy of the media object in the first image. In some embodiments, the translation distance between the copies of the media objects may correspond to a rank associated with the media objects. For example, a high rank may indicate a large translation distance to cause the media object to appear closer to a viewer and a low rank may indicate a smaller translation distance to cause the media object to appear farther from the viewer.

The two images are superimposed to produce a stereoscopic image. In the stereoscopic image, the media object will appear at an apparent distance from the viewer. The apparent distance may be related to the translation distance between the copies of the media object in the superimposed images. If multiple media objects appear in the stereoscopic image, some objects may appear to be closer to the viewer, and other objects may appear to be farther away, depending on their respective translation distances.

In order to separate the images presented to each of the viewer's eyes, the viewer may view the first and second images of the stereoscopic media guidance application using a stereoscopic optical device. Methods for generating stereoscopic media guidance application features are described in greater detail in Klappert et al., U.S. patent application Ser. No. 12/571,287, filed Sep. 30, 2009, which is hereby incorporated by reference herein in its entirety.

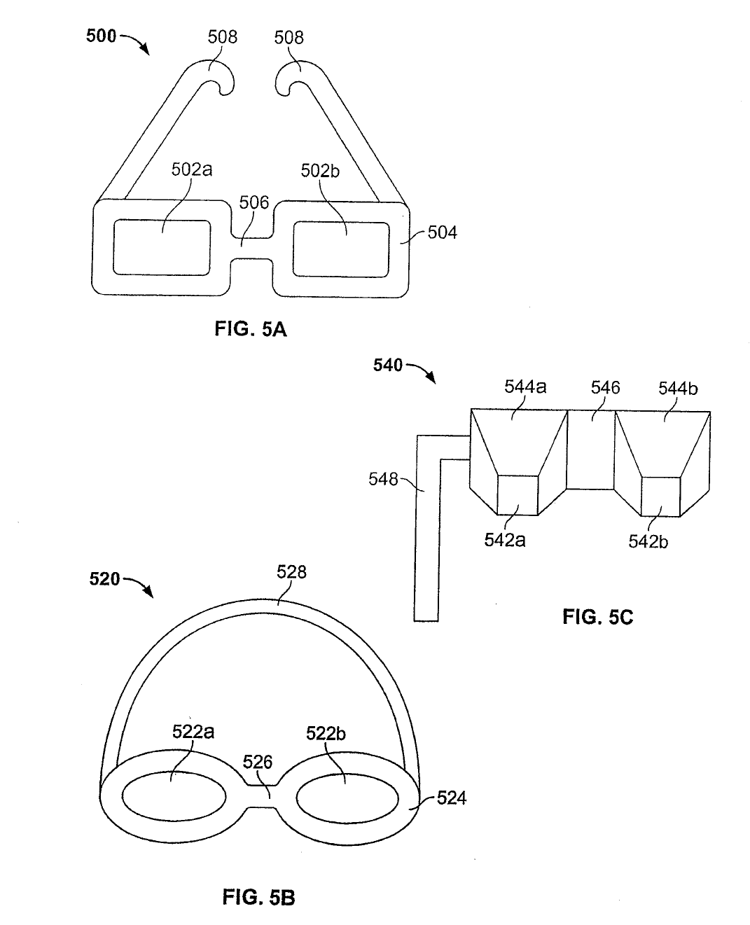

FIG. 5A shows an illustrative stereoscopic optical device in accordance with an embodiment of the invention. In particular, stereoscopic optical device 500 may be structured like a pair of eyeglasses. Stereoscopic optical device 500 may have a first opening 502a for a viewer's right eye and a second opening 502b for the viewer's left eye. When the viewer looks through opening 502a, the viewer only sees the image generated for the viewer's right eye. Similarly, when the viewer looks through opening 502b, the viewer only sees the image generated for the viewer's left eye. Openings 502a and 502b may be surrounded by a frame structure 504. Frame structure 504 may include a bridge 506 that may rest on the viewer's nose when the viewer wears stereoscopic optical device 500. Stereoscopic optical device 500 may also have sidepieces 508 that run along the side of the viewer's head and hook over the viewer's ears. Sidepieces 508 may be attached to frame structure 504 by screws, hinges, glue, or any other suitable attachment means.

In some embodiments, opening 502a may be covered by a first lens and opening 502b may be covered by a second lens. The lenses may be made of liquid crystal or some other suitable material. In some embodiments, the images seen through each of the lenses are superimposed by blocking and unblocking the lenses at appropriate times. When a lens is blocked, visible light is prevented from passing through the lens. When a lens is unblocked, visible light is allowed to pass through the lens.

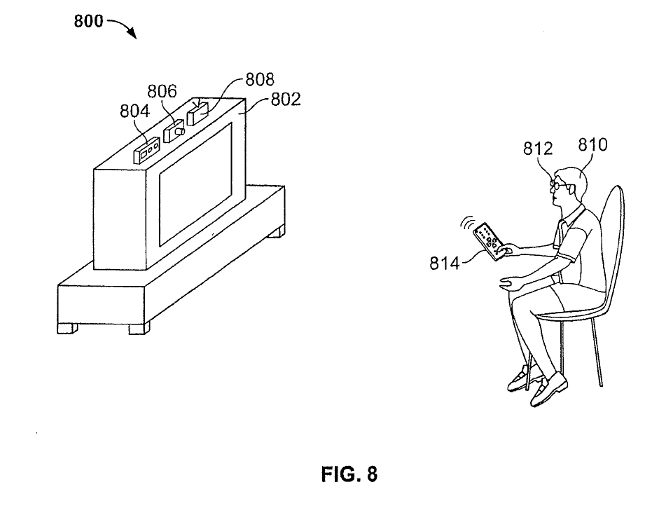

In some embodiments, a transmitter on a user equipment device may transmit a first signal that is received with a sensor. In response to receiving the first signal, the first lens is blocked and the second lens is unblocked. Then a second signal may be transmitted by the transmitter and received by the sensor. In response to receiving the second signal, the first lens is unblocked and the second lens is blocked. The transmitter, sensor, and signals will be described in more detail below in relation to FIG. 8.

In some embodiments, the lenses may be blocked and unblocked using a shuttering process. For example, the process of blocking and unblocking the lenses described above may be repeated many times per second, such that persistence of vision causes the viewer to be oblivious to the shuttering of the lenses and instead see a continuous stereoscopic image.

FIG. 5B shows an illustrative stereoscopic optical device in accordance with another embodiment of the invention. In particular, stereoscopic optical device 520 may be structured like a pair of goggles. Stereoscopic optical device 520 may have a first opening 522a for a viewer's right eye and a second opening 522b for the viewer's left eye. When the viewer looks through opening 522a, the viewer only sees the image generated for the viewer's right eye. Similarly, when the viewer looks through opening 522b, the viewer only sees the image generated for the viewer's left eye. Openings 522a and 522b may be surrounded by a frame structure 524. Frame structure 524 may include a bridge 526 that may rest on the viewer's nose when the viewer wears stereoscopic optical device 520. Stereoscopic optical device 520 may also have a band 528 that encircles the viewer's head to hold stereoscopic optical device 520 in place. Band 528 may be attached to frame structure 524 by screws, hinges, glue, or any other suitable attachment means.

In some embodiments, opening 522a may be covered by a first lens and opening 522b may be covered by a second lens. The lenses may be made of liquid crystal or some other suitable material. In some embodiments, the images seen through each of the lenses are superimposed by blocking and unblocking the lenses at appropriate times in the manner described above in relation to FIG. 5A.

FIG. 5C shows an illustrative stereoscopic optical device in accordance with a third embodiment of the invention. In particular, stereoscopic optical device 540 may be structured like a pair of opera glasses. Stereoscopic optical device 540 may have a first opening 542a for a viewer's right eye and a second opening 542b for the viewer's left eye. When the viewer looks through opening 542a, the viewer only sees the image generated for the viewer's right eye. Similarly, when the viewer looks through opening 542b, the viewer only sees the image generated for the viewer's left eye. Openings 542a and 542b may be surrounded by frame structures 544a and 544b, respectively. Frame structures 544a and 544b may be connected by a bridge 546 that may rest on the viewer's nose when the viewer wears stereoscopic optical device 540.

Stereoscopic optical device 540 may be configured to be positioned on a viewer's face such that when in a particular orientation, second opening 542b may allow visible light to pass from the viewer's right eye and only see a portion of a superimposed stereoscopic image generated for viewing with the viewer's right eye. Also, when in the particular orientation, first opening 542a may allow visible light to pass from the viewer's left eye and only see a portion of a superimposed stereoscopic image generated for viewing with the viewer's left eye. When seen together, the viewer's brain combines the images and perceives the combined images as a three dimensional object.

Stereoscopic optical device 540 may also have a handle 548 that the viewer may hold while looking through openings 542a and 542b. Handle 548 may be attached to either frame structure 544a or frame structure 544b by screws, hinges, glue, or any other suitable attachment means. The length of handle 548 may be adjustable so that stereoscopic optical device 540 may be used by viewers of different sizes.

In some embodiments, opening 542a may be covered by a first lens and opening 542b may be covered by a second lens. The lenses may be made of liquid crystal or some other suitable material. In some embodiments, the images seen through each of the lenses are superimposed by blocking and unblocking the lenses at appropriate times in the manner described above in relation to FIG. 5A.

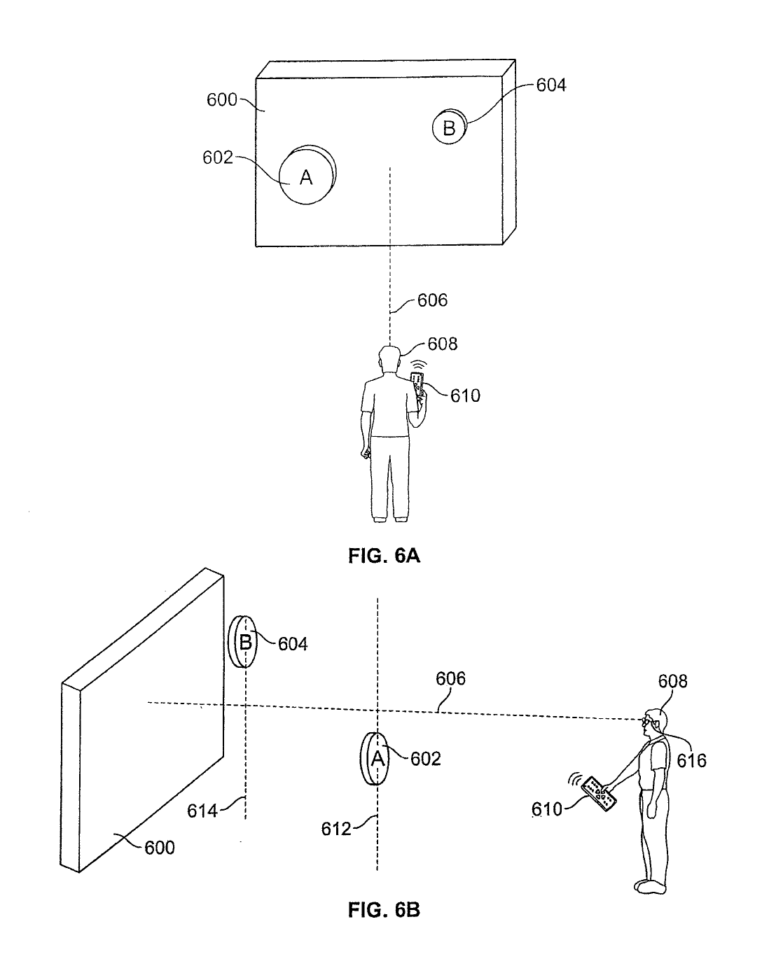

Stereoscopic optical devices, such as those described above in relation to FIGS. 5A-C, may be used when a viewer views a stereoscopic media environment. Illustrative stereoscopic media environment display screens are described in detail below in relation to FIGS. 6A-B.

FIG. 6A shows an illustrative front view of a display screen 600 of media objects appearing in different planes in accordance with an embodiment of the invention. A viewer 608 viewing display screen 600 sees a first media object 602 and a second media object 604. First media object 602 appears closer to the viewer than second media object 604 when viewed along an axis 606 that is normal to the display screen 600.

The viewer's perception of first and second media objects 602 and 604 is further illustrated in FIG. 6B. FIG. 6B shows an illustrative side view of the display screen illustrated in FIG. 6A, assuming first and second media objects 602 and 604 are actually three-dimensional. First media object 602 is displayed in a first plane, indicated by dotted line 612. Second media object 604 is displayed in a second plane, indicated by dotted line 614, that intersects axis 606 in a different location than first plane 612. Additional media objects (not shown) may appear in display screen 600 in the same planes as first and second media objects 602 and 604, or the additional media objects may appear in additional planes.

It should be understood that media objects such as first and second media objects 602 and 604 may appear to be behind display screen 600 as well as in front of display screen 600. In particular, first plane 612 and second plane 614 may both appear to be on the opposite side of display screen 600 from viewer 608. First plane 612 may appear closer to the side of display screen 600 opposite viewer 608 than second plane 614, such that first media object 602 displayed in first plane 612 still appears closer to viewer 608 than second media object 604 displayed in second plane 614 even though both media objects appear to be behind display screen 600.

In some embodiments, media objects in display screen 600 may be associated with respective ranks. Processing circuitry 306 may determine whether one or more media objects have respective associated ranks when generating the first and second images that are superimposed to produce display screen 600. If it is determined that one or more media objects have respective associated ranks, processing circuitry 306 may retrieve the ranks from storage 308.

Based on the retrieved rankings, processing circuitry 306 may determine a suitable apparent distance of each media object from viewer 608 relative to other media objects. Processing circuitry 306 may generate first and second images with the appropriate respective translation distances for each media object, such that the media objects appear at the suitable apparent distances from viewer 608 in the stereoscopic image that appears when viewer 608 views the first and second images using a stereoscopic optical device 616. Stereoscopic optical device 616 may be similar to one of the stereoscopic optical devices described above in relation to FIGS. 5A-C.

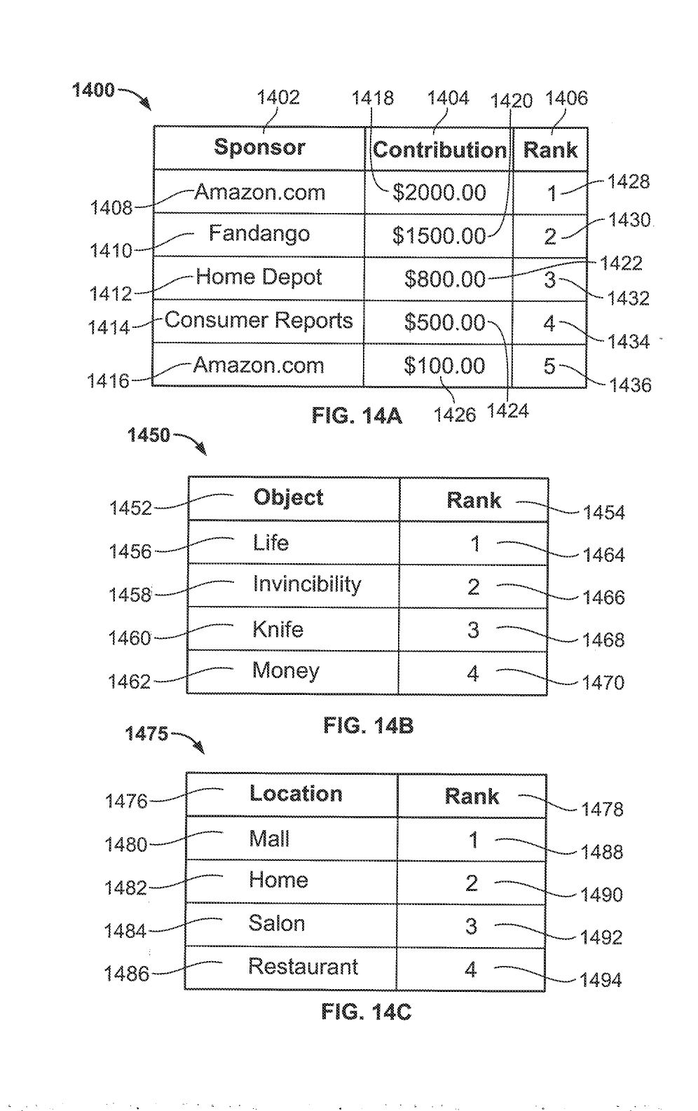

For example, processing circuitry 306 may determine that first and second media objects 602 and 604 have respective associated first and second ranks. The criteria for associating ranks with media objects is further described below in relation to FIGS. 14A-C. Processing circuitry 306 may retrieve the first and second ranks from storage 308. The first rank may be higher than the second rank, so processing circuitry 306 may determine that first media object 602 should have a closer apparent distance to viewer 608 than second media object 604. Processing circuitry 306 may generate the first and second images for display screen 600 with a first translation distance for first media object 602 and a second translation distance for second media object 604. The length of the first translation distance compared to the second translation distance may be such that the apparent distance of first media object 602 is closer to viewer 608 than the apparent distance of second media object 604 in the stereoscopic image produced by superimposing the first and second images. More specifically, processing circuitry 306 may display first media object 602 in a first plane parallel to display screen 600 that is closer to viewer 608 than a second plane parallel to display screen 600 in which second media object 604 is displayed.

Viewer 608 may interact with at least one of first and second media objects 602 and 604 with user input device 610, such as a user input device described above in relation to FIG. 3. Viewer interaction with a stereoscopic media environment using a user input device is discussed further below in relation to FIG. 8.

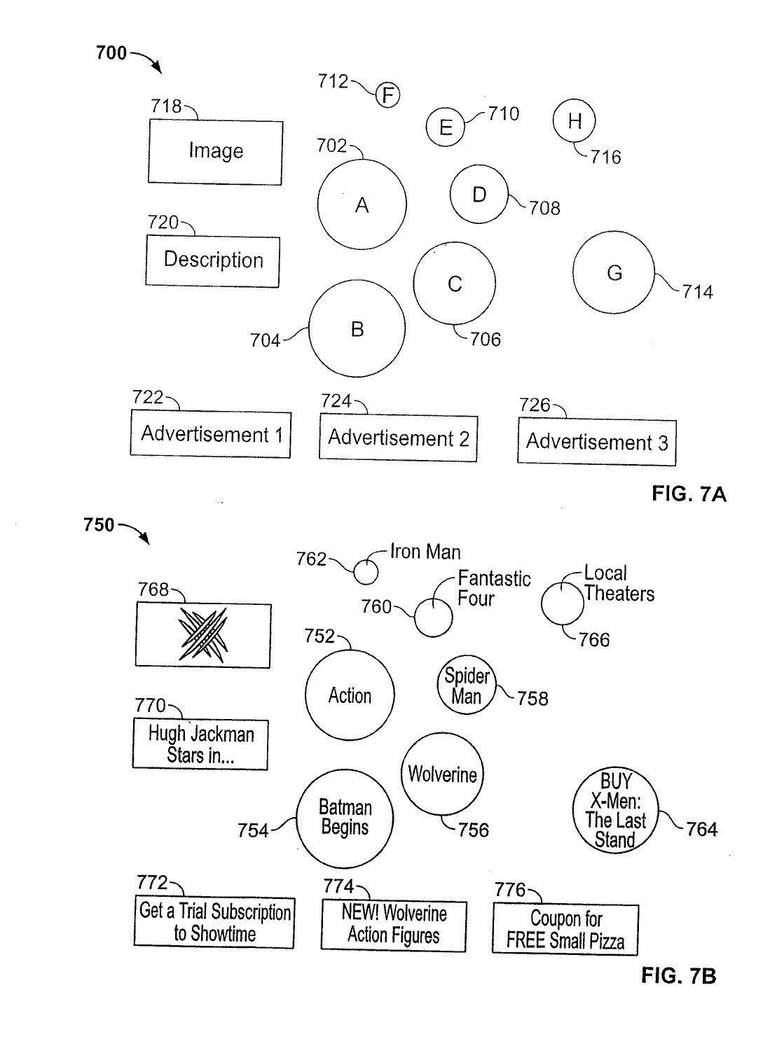

The stereoscopic media environment discussed above in relation to FIGS. 6A-B may be a stereoscopic media guidance application. A plurality of selectable media guidance objects may be arranged in a stereoscopic media guidance application display, as discussed below in relation to FIGS. 7A-B.

FIG. 7A shows an illustrative display screen 700 of selectable media guidance objects displayed in different planes in accordance with an embodiment of the invention. Selectable media guidance objects 702, 704, 706, 708, 710, and 712 may be arranged based on a planetary system. In particular, selectable media guidance object 702 may be in the position of a sun in a planetary system, and selectable media guidance objects 704, 706, 708, 710, and 712 may be in positions of planets orbiting the sun. More specifically, selectable media guidance object 702 (the “sun” object) may be perceived by the viewer when using the stereoscopic optical device as being in a center region in 3D space and selectable media guidance objects 704, 706, 708, 710, and 712 (“planet” objects) may be perceived by the viewer as surrounding selectable media guidance object 702 in 3D space. Processing circuitry 306 may generate first and second images for display screen 700 with various translation distances for the different media guidance objects such that different media guidance objects appear in different planes parallel to the display screen in display screen 700.

In some embodiments, “sun” object 702 may identify a group of media assets, and each of “planet” objects 704, 706, 708, 710, and 712 may correspond to one of the media assets of the group. For example, “sun” object 702 may identify a group of television programs and each of “planet” objects 704, 706, 708, 710, and 712 may represent a different television program in the group. In particular, “sun” object 702 may identify a group of television programs available or that are broadcast at a particular time or from a particular source (e.g., broadcast, satellite, Internet, terrestrial) and each of “planet” objects 704, 706, 708, 710, and 712 may represent a different media asset that is available or broadcast at the particular time or from the particular source. Similarly, “sun” object 702 may identify a group of cast members or directors of a media asset and each of “planet” objects 704, 706, 708, 710, and 712 may represent a different one of the cast members or directors in the group. “Planet” objects 704, 706, 708, 710, and 712 (discussed above and below) may represent media assets with images, videos, text, audio files, websites, or other representations unique to a media asset that identify the media asset to the viewer when the viewer perceives the media asset representation provided by one of “planet” objects 704, 706, 708, 710, and 712.

In some embodiments, “sun” object 702 may identify a genre of media assets and each of “planet” objects 704, 706, 708, 710, and 712 may represent a different one of the media assets in the group. For example, “sun” object 702 may identify a genre of movies, such as comedies or action movies, and each of “planet” objects 704, 706, 708, 710, and 712 may represent a different movie title in that genre. In some embodiments, “sun” object 702 may identify songs, musical artists, categories, emails a viewer receives, favorite media assets, playlists or videogames. For example, “sun” object 702 may identify a playlist of media assets and each of “planet” objects 704, 706, 708, 710, and 712 may represent a different one of the media assets in the playlist or other media assets of similar genre or duration.

In some embodiments, “sun” object 702 may identify a media asset, and each of “planet” objects 704, 706, 708, 710, and 712 may represent interactions associated with the identified media asset. For example, “sun” object 702 may identify a television program. “Planet” object 704 may represent an option to recommend the television program to another viewer, and “planet” object 706 may contain a hyperlink that may allow the viewer to obtain more information about the television program. In addition, “planet” object 708 may represent an option to chat with other viewers about the television program, while “planet” object 710 may invite the viewer to play a trivia game about the television program.

In some embodiments, a viewer may indicate a command to display additional selectable media guidance objects. Additional “planet” objects, selectable media guidance objects 714 and 716, may then appear that are of the same media asset type as the “planet” objects that are already displayed. For example, additional “planet” objects 714 and 716 may include more program listings for a certain time of day, or more media assets of a certain genre. “Planet” object 714 may appear in front of display screen 700, and “planet” object 716 may appear behind display screen 700. Alternately, both “planet” objects 714 and 716 may appear behind display screen 700, but “planet” object 714 may still appear closer to the viewer than “planet” object 716. “Planet” objects 714 and 716 may appear in different planes from the “planet” objects that are already displayed.

In some embodiments, additional “planet” objects 714 and 716 may be of different media asset types than the “planet” objects that are already displayed. In one embodiment, the “sun” object may be a movie genre and the “planet” objects that are already displayed may be movie titles in the genre. Additional “planet” objects 714 and 716 may be “planet” objects containing advertisements that may relate to one or more, or none, of the “sun” and “planet” objects that are already displayed. In some embodiments, one or more “planet” objects 714 and 716 may contain instructions for how to navigate the stereoscopic media guidance application. In some embodiments, one or more “planet” objects 714 and 716 may represent interactive content, such as chats or surveys. In some implementations, “planet” objects 714 and 716 may be displayed when selectable media guidance objects 702, 704, 706, 708, 710, and 712 are displayed, without the viewer indicating a command to display additional “planet” objects.

In some embodiments, “sun” object 702 may identify a media asset, and any of “planet” objects 704, 706, 708, 710, 712, 714, and 716 may include an advertisement related to the identified media asset. For example, if the identified media asset is a song, an advertisement may relate to local concerts given by the artist that sings the song or CDs containing the song. If the identified media asset is a sporting event, an advertisement may relate to food that the viewer may want to order while watching the event or jerseys of the teams that will be playing. In some embodiments, an advertisement may contain a discount for the advertised item. In some embodiments, some of the displayed advertisements may not be directly related to the identified media asset and may instead be local or regional advertisements.

In some embodiments, “planet” objects 704, 706, 708, 710, 712, 714, and 716 may have associated respective ranks. Processing circuitry 306 may generate first and second images for display screen 700 such that “planet” objects 704, 706, 708, 710, 712, 714, and 716 appear at respective apparent distances from the viewer based on the ranks, in accordance with the procedure described above in relation to FIGS. 6A-B. In some implementations, “planet” objects 704, 706, 708, 710, 712, 714, and 716 may be positioned and viewed as being equidistant from “sun” object 702. In other implementations, the distance of each of “planet” objects 704, 706, 708, 710, 712, 714, and 716 from “sun” object 702 may vary based on the respective ranks of the “planet” objects.

In some embodiments, the ranks associated with “planet” objects 704, 706, 708, 710, 712, 714, and 716 may correspond to how relevant “planet” objects 704, 706, 708, 710, 712, 714, and 716 are to “sun” object 702. Processing circuitry 306 may generate first and second images such that in the superimposed stereoscopic image, “planet” objects associated with higher ranks appear closer to “sun” object 702 or closer to the viewer.

Each of selectable media guidance objects 702, 704, 706, 708, 710, 712, 714, and 716 may be displayed in a different plane that intersects a normal of the screen at different points. For example, “sun” object 702 may appear to the viewer as first selectable media guidance object 602 appears to the viewer (e.g., may appear closer in 3D space to the viewer) and “planet” object 712 may appear to the viewer as second selectable media guidance object 604 appears to the user (e.g., may appear further away in 3D space from the viewer). In some implementations, selectable media guidance objects 702, 704, 706, 708, 710, 712, 714, and 716 may be spherical, rectangular, triangular, or any other geometrical shape.

In some embodiments, a viewer may input or select criteria for ranking selectable media guidance objects using a user input device. For example, a viewer may choose to rank “planet” objects 704, 706, 708, 710, 712, 714, and 716 based on their relevance to “sun” object 702. Processing circuitry 306 may then associate the “planet” objects with respective ranks according to the selected criteria and display the “planet” objects at appropriate apparent distances from the viewer.

In some embodiments, processing circuitry 306 may apply different ranking criteria to different media objects. For example, processing circuitry 306 may determine that “planet” objects 704, 706, 708, 710, and 712 represent movies of the genre represented by “sun” object 702. Processing circuitry 306 may also determine that “planet” objects 714 and 716 represent advertisements. Processing circuitry 306 may then associate ranks with “planet” objects 704, 706, 708, 710, and 712 based on a first set of criteria and associate ranks with “planet” objects 714 and 716 based on a second set of criteria. For example, processing circuitry 306 may associate ranks with “planet” objects 704, 706, 708, 710, and 712 based on the availability of the movies represented by the “planet” objects. Processing circuitry 306 may associate ranks with “planet” objects 714 and 716 based on the relevance of the relevant advertisements to movies. Processing circuitry 306 may display each set of “planet” objects according to its respective criteria, as discussed above in relation to FIGS. 6A-B.

In some embodiments, the viewer may change the ranking criteria using a user input device. For example, processing circuitry 306 may detect an up and down movement on the input device (e.g., based on input processing circuitry 306 receives from an accelerometer and/or gyroscope) and as a result may change the ranking criteria and redisplay the “planet” objects accordingly. In some implementations, the ranking criteria may be changed based on a particular direction the input device is jerked towards. For example, when processing circuitry 306 determines that the input device is jerked towards a direction of a line that forms a 45 degree angle relative to a normal of the display, processing circuitry 306 may set the ranking criteria to be based on the availability of the media assets represented by the “planet” objects. For example, media assets that are available on demand may be associated with higher ranks than media assets that are scheduled to be broadcast at a set time. When processing circuitry 306 determines that the input device is jerked towards a direction of a line that forms a 90 degree angle relative to a normal of the display, processing circuitry 306 may use both relevance to “sun” object 702 and availability as criteria in associating ranks with the “planet” objects. More specifically, different types and combinations of ranking criteria may be associated with different directions in which the input device is moved or jerked.

In some embodiments, the selectable media guidance objects may appear semi-transparent, partially-transparent or fully transparent. For example, “planet” object 706 may appear closer in 3D space to the viewer than “planet” object 708. “Planet” object 706 may partially or fully obstruct the viewer's view of “planet” object 708. “Planet” object 706 may appear semi-transparent, partially-transparent or fully transparent so that the viewer may still see “planet” object 708 through “planet” object 706. In particular, the viewer may see both “planet” object 708 and “planet” object 706 in the same portion of the screen. In some implementations, the level of transparency may be adjusted (e.g., by the viewer or the system). For example, the viewer may set a high level of transparency which may cause the transparent effect to be closer to fully transparent (e.g., to appear closer to being a window) allowing more visible light to pass through. Alternatively, the viewer may set a lower level of transparency which may cause the transparent effect to be closer to opaque or translucent (e.g., to appear closer to being a frosted window) allowing less visible light to pass through such that one object appears slightly more opaque than another. In some embodiments, the level of transparency of a media object may be based on the rank associated with the media object. For example, media objects associated with higher ranks may appear closer to opaque than media objects associated with lower ranks.

In some embodiments, an image box 718 and a description box 720 may be displayed with selectable media guidance objects 702, 704, 706, 708, 710, 712, 714, and 716. Image box 718 may display an image associated with one of “planet” objects 702, 704, 706, 708, 710, 712, 714, and 716. In some embodiments, the image in image box 718 may be a still image. For example, the still image may be a photograph of an actor or a screen shot from a television show. In other embodiments, the image in image box 718 may be a moving image, such as a rotating image or a streaming clip of content. In some embodiments, the moving image may be a movie trailer or an interview with a cast member.

Description box 720 may display text describing one of selectable media guidance objects 702, 704, 706, 708, 710, 712, 714, and 716. In some embodiments, the text in description box 720 may be sized such that all of the text may be viewed at once. In other embodiments, the user may manually scroll up and down or side to side within description box 720 in order to view all of the text. In still other embodiments, the text in description box 720 may automatically scroll up and down or side to side so that the user may read all of the text. In yet other embodiments, some text may be displayed in description box 720, and the user may select description box 720 in order to read the rest of the text. The text in description box 720 may relate to any or all of selectable media guidance objects 702, 704, 706, 708, 710, 712, 714, and 716. For example, the text in description box 720 may be a biography of an actor, a plot synopsis, lyrics to a song, or a description of a videogame.

In some embodiments, selectable media guidance objects 702, 704, 706, 708, 710, 712, 714, and 716 themselves may contain images or text, or both. The images and text in selectable media guidance objects 702, 704, 706, 708, 710, 712, 714, and 716 may be displayed in any or all of the manners described above in relation to image box 718 and description box 720.

In some embodiments, advertisements 722, 724, and 726 may be displayed along with the “sun” and “planet” objects. Advertisements 722, 724, and 726 are rectangular in display screen 700 but may be any shape. Some of advertisements 722, 724, and 726 may appear in front of the display screen, and some may appear behind the display screen. Advertisements 722, 724, and 726 may appear in different planes from the selectable media guidance objects that are already displayed.

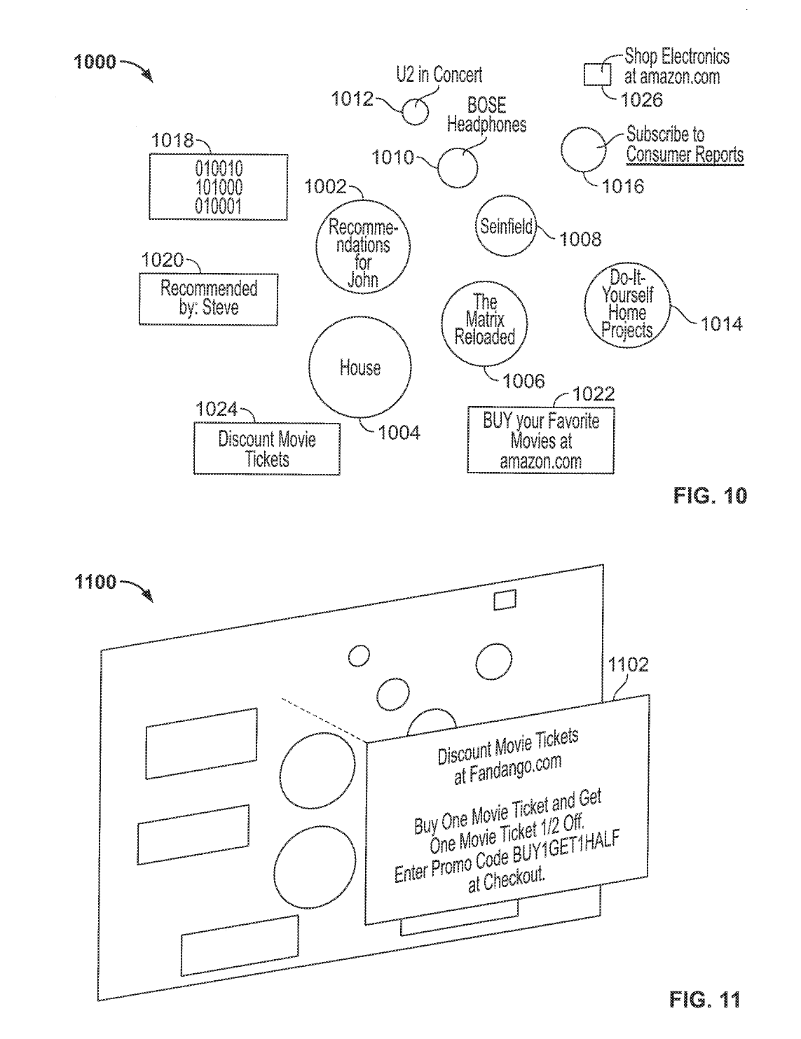

In some embodiments, advertisements 722, 724, and 726 may be positioned and viewed as being on the same level (or height) as selectable media guidance objects 702, 704, 706, 708, 710, 712, 714, and 716. In other embodiments, advertisements 722, 724, and 726 may appear to be at a different level than any of selectable media guidance objects 704, 706, 708, 710, 712, 714, and 716. In some embodiments, advertisements 722, 724, and 726 will all appear at the same distance from the viewer. In other embodiments, advertisements 722, 724, and 726 will appear at different distances from the viewer based on associated rankings. Ranking and displaying advertisements is discussed further below in relation to FIG. 14A. In some embodiments, one or more of advertisements 722, 724, 726 are selectable. Selectable advertisements are discussed further below in relation to FIGS. 10-11.

Advertisements 722, 724, and 726 may relate to one or more of the displayed “sun” and “planet” objects, or to none at all. For example, if “planet” objects 704, 706, 708, 710, and 712 identify movies, advertisement 722 may relate to one movie, such as by advertising a DVD of the movie. Advertisement 724 may relate to movies in general, such as by advertising a website where a viewer can buy discount movie tickets. Advertisement 726 may have nothing to do with movies, such as by advertising the grand opening of a local clothing store.

FIG. 7B shows an illustrative display screen 750 of movie representations displayed in different planes in accordance with an embodiment of the invention. In particular, selectable media guidance objects 752, 754, 756, 758, 760, 762, 764, and 766 may be arranged based on a planetary system. Each of selectable media guidance objects 752, 754, 756, 758, 760, 762, 764, and 766 may be displayed in a different plane that intersects a normal of the screen at a different point or location. Selectable media guidance object 752 may be the “sun” object and identifies a movie genre, Action. Selectable media guidance object 752 may be the same or have similar functionality as selectable media guidance object 702 (FIG. 7A). Selectable media guidance objects 754, 756, 758, 760, and 762 may be “planet” objects and may correspond to movie titles in the action movie genre identified by selectable media guidance object 752. Selectable media guidance objects 764 and 766 may be additional “planet” objects and may correspond to advertisements related to movies. For example, “planet” object 764 may be an advertisement for local movie theaters, and “planet” object 764 may be an advertisement for a DVD of a particular action movie. The advertisements in selectable media guidance objects 764 and 766 may correspond to one or more of the displayed movie titles or to none at all. Selectable media guidance objects 754, 756, 758, 760, 762, 764, and 766 may be the same or have similar functionality as selectable media guidance objects 704, 706, 708, 710, 712, 714, and 716 (FIG. 7A). The “planet” objects 754, 756, 758, 760, 762, 764, and 766 may include images associated with the movie titles or advertisements as well as the text of the movie titles or advertisements.

In another embodiment, the “sun” object may identify a time of day, and the “planet” objects may correspond to programs scheduled for that time of day. In yet another embodiment, the “sun” object may identify a genre of movies, and the “planet” objects may correspond to movies belonging to that genre.

Image box 768 in FIG. 7B displays an image associated with a “planet” object 756. In particular, the image in image box 768 may be an “X” scratched by Wolverine, the main character in the movie identified by “planet” object 756. In another embodiment, the image in image box 768 may be a trailer for the movie “Wolverine”. In yet another embodiment, the image in image box 768 may be an image associated with one of selectable media guidance objects 752, 754, 758, 760, 762, 764, and 766.

Description box 770 in FIG. 7B displays text associated with one of the “planet” objects. In particular, the text in description box 770 may be a plot synopsis of the movie displayed in selectable media object 756, “Wolverine”. In another embodiment, the text in description box 770 may list the main actors in “Wolverine”. In other embodiments, the text in description box 770 may be a plot synopsis or list of main actors for one of the movies in one of the other “planet” objects.

Advertisements 772, 774, and 776 may also appear in display screen 750. Each of advertisements 772, 774, and 776 may be displayed in a different plane that intersects a normal of the screen at a different point or location. Advertisements 772, 774, and 776 may be related to one or more of the “sun” and “planet” objects that appear in display screen 750, or to none of them. For example, advertisement 772 may be related to movies in general, such as by advertising a subscription to a movie channel, Showtime. Advertisement 774 may be related to a particular movie, such as by advertising action figures from “Wolverine”, a movie in a displayed “planet” object. Advertisement 776 may not be related to movies at all, such as by advertising a coupon for a local pizza store. Advertisements 772, 774, and 776 may be the same or have similar functionality as advertisements 722, 724, and 726 (FIG. 7A). In some embodiments, one or more of advertisements 772, 774, and 776 may be selectable.

A stereoscopic media environment, such as the stereoscopic media guidance applications described above in relation to FIGS. 7A-B, may be displayed and navigated using a plurality of user equipment devices and peripheral devices. Methods for navigating a stereoscopic media guidance application are described in greater detail in Klappert et al., U.S. patent application Ser. No. 12/571,283, filed Sep. 30, 2009, which is hereby incorporated by reference herein in its entirety.

FIG. 8 shows an illustrative arrangement 800 of user equipment devices and peripheral devices in accordance with an embodiment of the invention. A stereoscopic media environment may be displayed on the screen of a television set 802. A viewer 810 may view the stereoscopic media guidance application using a stereoscopic optical device 812, such as one of the stereoscopic optical devices described above in relation to FIGS. 5A-C. A set top box 804 may be mounted on television set 802 or may be incorporated into television set 802. A camera 806 may also be mounted on or incorporated into television set 802. As referred to herein, user television equipment may include each or all set top box 804, camera 806, and the television set 802 independently or jointly. Camera 806 may detect movements of viewer 810 or user input device 814. In some embodiments, camera 806 may be an infrared camera. The infrared camera may detect movements of viewer 810 by forming a thermal image of viewer 810. Alternatively, user input device 814 may emit an infrared light that may be detected by the infrared camera.

A transceiver 808 may also be mounted on or incorporated into television set 802. Transceiver 808 may also be included in the user television equipment referred to above and below. Transceiver 808 may be used to control stereoscopic optical device 812. For example, transceiver 808 may transmit infrared signals that are received by a sensor on stereoscopic optical device 812. The infrared signals may block and unblock the lenses on optical device 812 so that viewer 810 sees a stereoscopic image, as described above in relation to FIGS. 5A-C. For example, processing circuitry 306 may display an image on the screen for the viewer to view with only the left eye and accordingly may instruct transceiver 808 to send a message to the viewer's optical device to block the right lens and unblock the left lens. At a later time (e.g., milliseconds or microseconds), processing circuitry 306 may display an image on the screen for the viewer to view with only the right eye and accordingly may instruct transceiver 808 to send a message to the viewer's optical device to block the left lens and unblock the right lens.

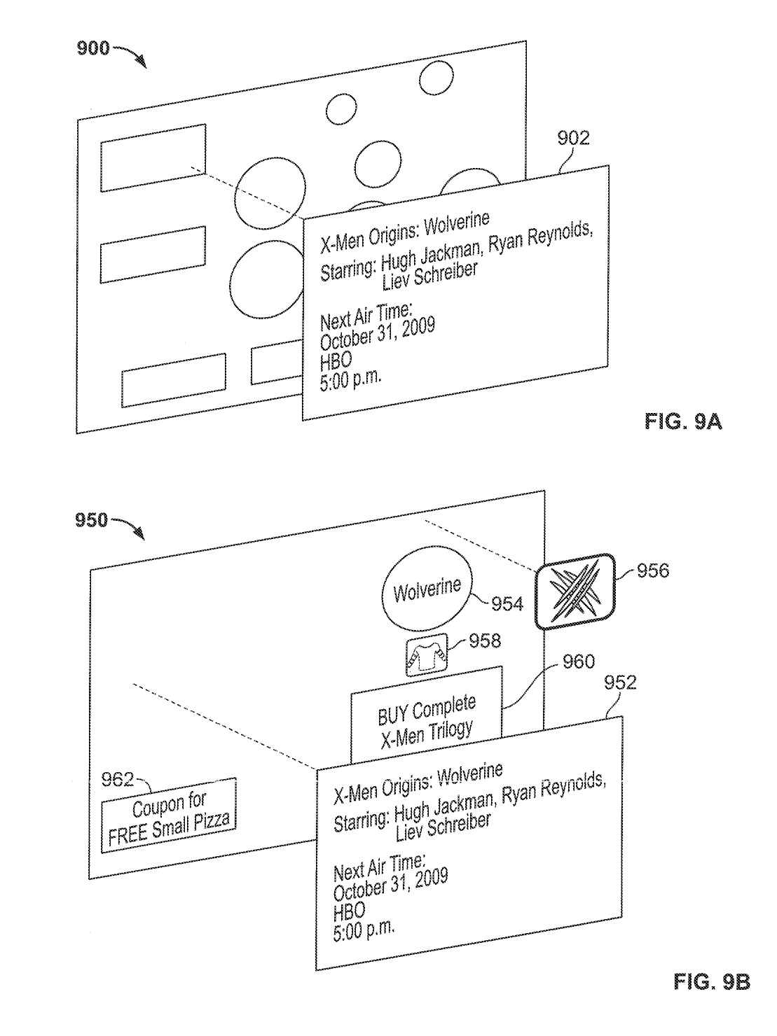

Transceiver 808 may also receive signals from user input device 814. For example, viewer 810 may press a button on user input device 814 to select a displayed selectable media guidance object, such as advertisement 772 in FIG. 7B. User input device 814 may transmit a signal, such as an infrared signal, indicating a viewer selection that is received by transceiver 808. In some embodiments, transceiver 808 may work in tandem with camera 806 to detect movements of viewer 810 and user input device 814. For example, camera 806 may detect broad arm movements of viewer 810, while transceiver 808 receives information about the motion and orientation of user input device 814 gathered by an accelerometer inside user input device 814. Based on the information collected by camera 806 and transceiver 808, the stereoscopic media guidance application display may be modified, as discussed in detail below in relation to FIGS. 9A-B, 10, and 11.

In some embodiments, selection of a displayed “planet” object will cause additional information associated with the selected “planet” object to be displayed. FIGS. 9A-B show illustrative configurations 900 and 950, respectively, of additional information about a selected media object on a display screen in accordance with an embodiment of the invention. Additional information about, for example, a selected movie title may include information regarding what the movie is about, which actors appear in the movie, or when and on which channels the movie will air.

A viewer viewing the stereoscopic media guidance application display screen 750 of FIG. 7B may request additional information about the movie “Wolverine”, which corresponds to “planet” object 756, using a user input device. In one implementation, illustrated in FIG. 9A, additional information 902 is overlaid over the displayed media objects. Additional information 902 may include the complete title of the movie, the main actors, and relevant information about the movie's next airing. The text in the media objects behind overlaid additional information 902 may disappear, leaving only outlines of the media objects not obscured by overlaid additional information 902. In some embodiments, additional information 902 may appear semi-transparent, partially-transparent, or fully transparent such that the outlines of media objects behind additional information 902 may be seen. In some embodiments, the level of transparency may be adjusted (e.g., by the viewer or the system).

In another implementation, illustrated in FIG. 9B, additional information 952 may be displayed in a display screen 950 different from the previous display screen from which the additional information was requested. Returning to the example of a viewer selecting the movie “Wolverine” in stereoscopic media guidance application display screen 750 of FIG. 7B, a media object 954 that is a copy of the selected “planet” object may appear in display screen 950. Media object 954 may not be selectable since it may be a copy of the media object that was already selected. Additional information 952 may include the complete title of the movie, the main actors, and relevant information about the movie's next airing.

Display screen 950 may also include media objects 956, 958, 960, and 962. Media objects 956, 958, 960, and 962 may or may not relate to the selected “planet” object. For example, media objects 956 and 958 may be images that are related to “Wolverine”, such as an “X” scratched by Wolverine's claws and a jacket that Wolverine wears. Media objects 956 and 958 may have associated ranks, and media object 956 may be associated with a higher rank than media object 958. Processing circuitry 306 may display media object 956 at an apparent distance closer to the viewer than media object 958, in accordance with the procedure described above in relation to FIGS. 6A-B.

Media objects 960 and 962 may be advertisements. Advertisement 960 may advertise DVDs of movies that are related to “Wolverine”, such as the rest of the X-Men movies. Advertisement 962, which may be a food advertisement, may not relate to “Wolverine” at all. In some embodiments, advertisement 960 may be associated with a higher ranking than advertisement 962, so processing circuitry 306 may display advertisement 960 at an apparent distance closer to the viewer or larger than advertisement 962.

In some embodiments, the “sun” object in a stereoscopic media guidance application display screen may identify a viewer profile, and the “planet” objects may represent recommendations of media content for the viewer profile. FIG. 10 shows an illustrative display screen 1000 of recommended media content representations displayed in different planes in accordance with an embodiment of the invention.

In one embodiment, the “sun” object, selectable media guidance object 1002, may identify a viewer profile, and each of the “planet” objects, selectable media guidance objects 1004, 1006, 1008, 1010, and 1012, may represent a different recommendation for the viewer profile. In some embodiments, the recommendations may be based on a viewing history associated with the viewer profile. The recommendations may be for media assets related to media assets in the viewing history, such as movies or television shows of the same genre, documentaries on a similar topic, or songs written by the same artist. In some embodiments, the recommendations may be for products that may interest the user, such as movie posters, DVDs, or sports memorabilia. The product recommendations may be based on media assets the viewer has watched or products the viewer has previously purchased. In some embodiments, the recommendations may be based on the preferences of friends of the viewer. In some embodiments, the recommendations may be based on endorsements from media personalities, such as Oprah, or publications, such as Consumer Reports. Each of “planet” objects 1004, 1006, 1008, 1010, and 1012 may be associated with a respective rank. Processing circuitry 306 may display the “planet” objects in different planes, as described above in relation to FIGS. 6A-B. The ranks may be based on criteria such as how closely related a recommended media asset is to the viewer's viewing history, or how highly rated a product is by other viewers or organizations.

“Sun” object 1002 may identify a group of “planet” objects as recommendations for a viewer, John. “Planet” object 1004 may represent a television show, “House”. “House” may appear as a recommendation because John's viewer profile indicates that he has watched other medical dramas such as “ER” and “Grey's Anatomy”. “Planet” object 1006 may represent a movie, “The Matrix Reloaded.” “The Matrix Reloaded” may appear as a recommendation because John's viewer profile indicates that he watched the first “Matrix” movie. “Planet” object 1008 may represent another television show, “Seinfeld”. “Seinfeld” may appear as a recommendation because one of John's friends liked it and wanted to recommend it to John. “Planet” object 1010 may represent an object, headphones made by Bose. The Bose headphones may appear as a recommendation because they were rated highly in the latest issue of Consumer Reports. “Planet” object 1012 may represent an upcoming U2 concert. The U2 concert may appear as a recommendation because several of John's friends on a social networking site have indicated that they will be attending the concert.

In some embodiments, additional “planet” objects 1014 and 1016 may appear in display screen 1000. In some embodiments, “planet” objects 1014 and 1016 may be additional recommendations for a viewer. In other embodiments, “planet” objects 1014 and 1016 may be advertisements. Advertisements appearing in “planet” objects 1014 and 1016 may be related to one or more of the other displayed “planet” objects, or to media assets in the viewer's viewing history, or to neither the displayed “planet” objects nor the viewer's viewing history. For example, “planet” object 1014 may advertise a website for do-it-yourself home projects because the viewer watches television shows like “Home Improvement”. “Planet” object 1016 may advertise the magazine Consumer Reports because one or more recommended items appearing in other “planet” objects were recently reviewed or endorsed by the magazine. In some embodiments, “planet” objects 1014 and 1016 may be associated with respective ranks, as discussed further below in relation to FIG. 14A.

In some embodiments, image box 1018 and description box 1020 may be displayed with the recommendations in display screen 1000. Image box 1018 may display an image associated with “sun” object 1002 or any of “planet” objects 1004, 1006, 1008, 1010, 1012, 1014, or 1016. In one embodiment, image box 1018 may be associated with “planet” object 1006, a recommendation for the movie “The Matrix Reloaded”. Image box 1018 may contain an image of a screen of a computer linked to the Matrix. Alternately, the image in image box 1018 may be a photograph of the cast from “The Matrix Reloaded”, a trailer, or any other suitable still or moving image related to the movie.

Description box 1020 may display text associated with “sun” object 1002 or any of “planet” objects 1004, 1006, 1008, 1010, 1012, 1014, or 1016. In one embodiment, description box 1020 may be associated with “planet” object 1006. The text in description box 1020 may tell the viewer who recommended “The Matrix Reloaded”. Alternately, the text in description box 1020 may include a plot synopsis of “The Matrix Reloaded”, a list of the main actors, information about the next airing of the movie, or any other suitable text related to the movie.

Advertisements 1022, 1024, and 1026 may also appear in display screen 1000. Each of advertisements 1022, 1024, and 1026 may be displayed in a different plane that intersects a normal of the screen at a different point or location. Advertisements 1022, 1024, and 1026 may be related to one or more of the recommended media assets or products that appear in display screen 1000, or to none of them. For example, since “planet” object 1006 represents a recommended movie, advertisements 1022 and 1024 may be related to movies in general. Advertisement 1022 may advertise a website, amazon.com, where viewers can buy their favorite movies on DVD. Advertisement 1024 may offer viewers movie tickets at a discounted price. Advertisement 1026 may not be related to movies at all, and instead may be related to a product, since “planet” object 1010 represents a recommended product. Advertisement 1026 may be another advertisement for amazon.com, but inviting the viewer to shop for electronics instead of movies. Alternately, advertisement 1026 may not be related to any of the recommendations. For example, advertisement 1026 may be an advertisement for special menu items at a restaurant. In some embodiments, advertisements 1022, 1024, and 1026 may be associated with respective ranks, as discussed further below in relation to FIG. 14A.

In some embodiments, one or more of advertisements 1022, 1024, and 1026 may be selectable. In some embodiments, processing circuitry 306 may receive a viewer selection of an advertisement. For example, processing circuitry 306 may receive a viewer selection from a user input device, such as user input device 310 discussed above in relation to FIG. 3. Processing circuitry 306 may automatically retrieve ordering information (e.g., credit card and account user information) and transmit the retrieved information and information that identifies the viewer selection (e.g., selection of the advertisement) to a remote server to cause the product represented by the selected advertisement to be automatically purchased. Processing circuitry 306 may display information related to the automatic purchase in display screen 1000. In other embodiments, processing circuitry 306 may display additional information about a selected advertisement in response to receiving a viewer selection, as discussed below in relation to FIG. 11.

FIG. 11 shows an illustrative configuration 1100 of additional information about a selected advertisement on a display screen in accordance with an embodiment of the invention. If a viewer selects advertisement 1024, discussed above in relation to FIG. 10, additional information 1102 about the advertisement may appear on the screen. Additional information 1102 may be overlaid over the displayed media objects. Additional information 1102 may include the address of the website where the viewer may purchase discounted movie tickets, fandango.com, and explain the terms and details of the discount. In some embodiments, additional information 1102 may include a link to the advertised website.

The text in the media objects behind overlaid additional information 1102 may disappear, leaving only outlines of the media objects not obscured by overlaid additional information 1102. In some embodiments, additional information 1102 may appear semi-transparent, partially-transparent, or fully transparent such that the outlines of media objects behind additional information 1102 may be seen. In some embodiments, the level of transparency may be adjusted (e.g., by the viewer or the system).

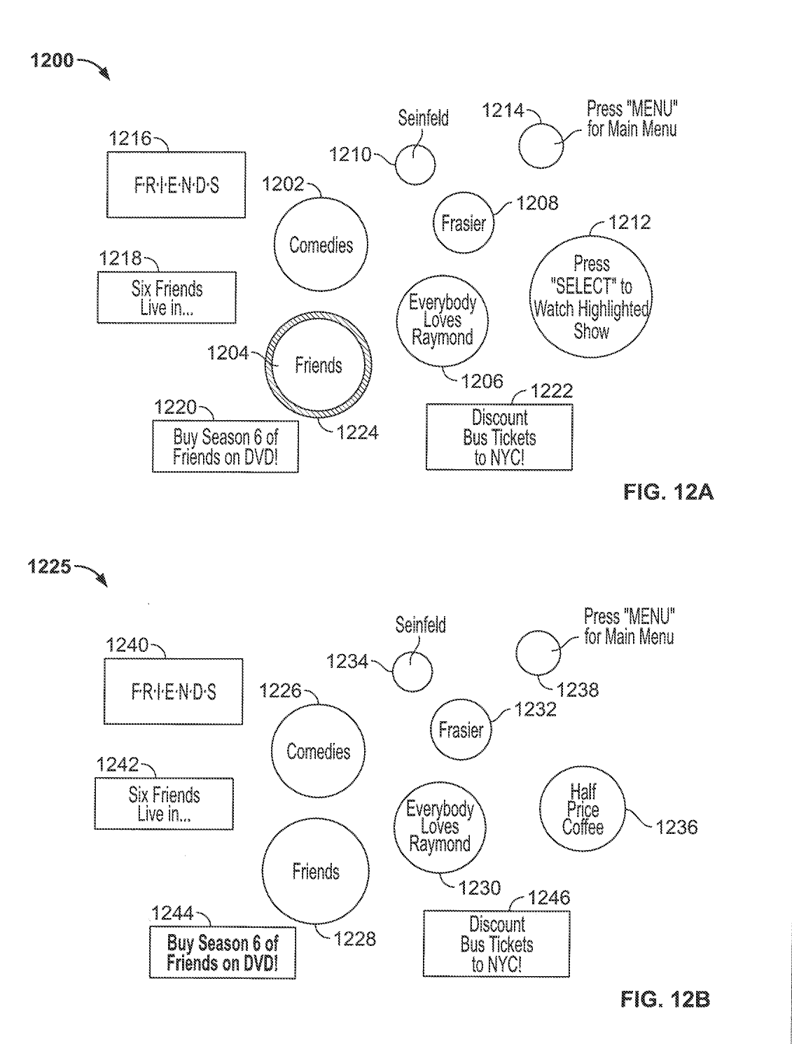

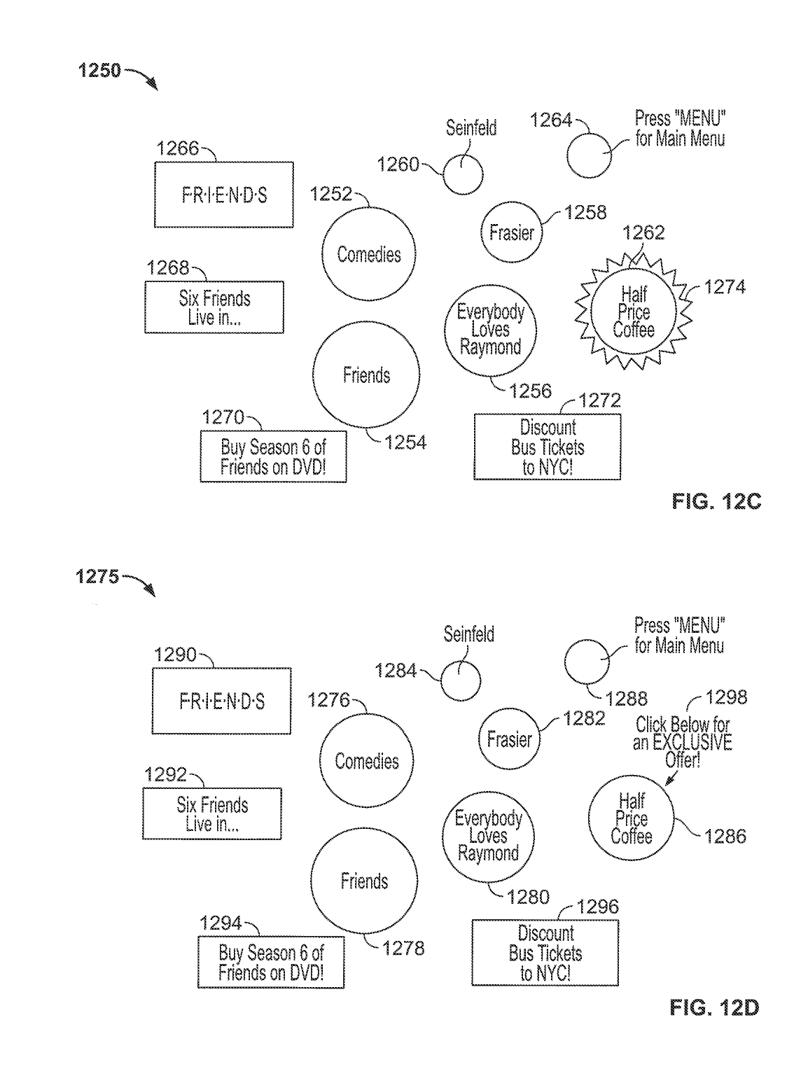

In some embodiments, a media object may be visually distinguished from other displayed media objects. FIGS. 12A-D show illustrative configurations 1200, 1225, 1250, and 1275, respectively, for visually distinguishing a media object on a display screen in accordance with various embodiments of the invention. Display screens 1200, 1225, 1250, and 1275 all show planetary arrangements, as described above in relation to FIGS. 7A-B.

“Sun” and “planet” objects 1202, 1204, 1206, 1208, 1210, 1212, and 1214 in display screen 1200 of FIG. 12A each have functionalities that are the same or similar to the “sun” and “planet” objects discussed above in relation to FIG. 7A. Each of “sun” and “planet” objects 1202, 1204, 1206, 1208, 1210, 1212, and 1214 in FIG. 12A may be displayed in a different plane that intersects the normal of the screen at a different point. “Sun” object 1202 may identify a genre of television shows, Comedies, or any group of media assets as discussed above. “Planet” objects 1204, 1206, 1208, and 1210 may each identify various television shows that are comedies.

In some embodiments, “planet” objects 1212 and 1214 may contain instructions on how to navigate the stereoscopic media guidance application. “Planet” object 1212 may instruct the viewer to press the “SELECT” button on the user input device in order to watch the show that is visually distinguished by highlight region 1224. “Planet” object 1214 may instruct the viewer to press the “MENU” button on the user input device in order to return to the main menu of the stereoscopic media guidance application. In some embodiments, one or both of “planet” objects 1212 and 1214 may represent an advertisement. “Planet” objects 1212 and 1214 may appear in the same plane in display screen 1200, or “planet” objects 1212 and 1214 may appear in different planes. “Planet” objects 1212 and 1214 may be related to one, more than one, or none of the other displayed “planet” objects. In some embodiments, processing circuitry 306 may determine that “planet” objects 1212 and 1214 have associated respective ranks and may display “planet” objects 1212 and 1214 at different apparent distances in accordance with the procedure described above in relation to FIGS. 6A-B.

The image in image box 1216 may correspond to one of the displayed “sun” or “planet” objects. In one embodiment, the image in image box 1216 may correspond to the television show identified in “planet” object 1204, “Friends”. “Planet” object 1204 in FIG. 12A may be visually distinguished by a highlight region 1224. “Planet” object 1204 may be visually distinguished for various reasons. For example, “planet” object 1204 may be visually distinguished because “Friends” is the viewer's favorite show. “Planet” object 1204 may also be visually distinguished because it is highly rated by other viewers, because another viewer recommended it, because it has the highest associated ranking out of all the “planet” objects, or because the viewer has set a recording for or reminder to watch “Friends”. In some embodiments, “planet” object 1204 may be visually distinguished because the broadcaster of “Friends” has paid to have media objects representing “Friends” stand out more than other media objects. In the event that multiple broadcasters have paid to have their respective shows displayed more prominently, processing circuitry 306 may determine which broadcaster has paid the most and make the show associated with that broadcaster appear the closest to the viewer out of all represented shows. It should be understood that “planet” object 1204 may be visually distinguished for any one or any combination of the above reasons, and that “planet” object 1204 may be visually distinguished for another reason or combination of reasons not listed above.

In some embodiments, highlight region 1224 may be completely semi-transparent or transparent. In other embodiments, highlight region 1224 may be semi-transparent or transparent in areas that overlap a selectable media guidance object and opaque everywhere else. In some embodiments, highlight region 1224 may bring the highlighted media object into focus.

Description box 1218 may display text associated with “planet” object 1204. In particular, the text in description box 1218 may be a general overview of what the television show “Friends” is about. In some embodiments, description box 1218 and/or image box 1216 may appear to lie in the same plane as the selectable media guidance object with which they are associated. For example, description box 1218 and/or image box 1216 may include information about the show “Friends” identified by “planet” object 1204. “Planet” object 1204 may appear to lie in a plane that intersects the normal of the screen at a first location which makes “planet” object 1204 appear to be at a closer distance to the viewer than “planet” object 1208. Accordingly, description box 1218 and/or image box 1216 may also lie in the same plane as “planet” object 1204 and appear to be the same distance away from the viewer as “planet” object 1204. This may allow the viewer to visually identify to which of the displayed selectable media guidance objects description box 1218 and/or image box 1216 correspond.

In some embodiments, description box 1218 and/or image box 1216 may appear in the plane of the screen while the selectable media guidance objects appear in planes in front of and/or behind the screen. In some embodiments, one or more selectable media guidance objects may appear in the plane of the screen while other selectable media guidance objects appear in planes in front of and/or behind the screen. For example, description box 1218 and image box 1216 may appear in the plane of the screen with selectable media guidance object 1204 while the other selectable media guidance objects appear in planes in front of and behind the screen.

In some embodiments, advertisements 1220 and 1222 may appear in display screen 1200. Each of advertisements 1220 and 1222 may be displayed in a different plane that intersects a normal of the screen at a different point or location. Advertisements 1220 and 1222 may be related to one or more of the media objects that appear in display screen 1200. For example, advertisement 1220 may be related only to “planet” object 1204, which represents the television show “Friends”. Advertisement 1220 may invite the viewer to purchase the sixth season of “Friends” on DVD. Advertisement 1222 may be related to several “planet” objects, namely “planet” objects 1204, 1206, and 1210, which all represent television shows that take place in New York City. Advertisement 1222 may offer the viewer discounted bus tickets to New York City. In some embodiments, advertisements 1220 and 1222 may not be related to any of the displayed media objects in display screen 1200. In some embodiments, processing circuitry 306 may determine that advertisements 1220 and 1222 have associated respective ranks and may display advertisements 1220 and 1222 at different apparent distances in accordance with the procedure described above in relation to FIGS. 6A-B. In some embodiments, advertisements 1220 and 1222 may be selectable.

In some embodiments, a media object may be visually distinguished with bolded text, as shown in display screen 1225 of FIG. 12B. Media objects 1226, 1228, 1230, 1232, 1234, 1238, 1240, 1242, and 1246 of FIG. 12B correspond to media objects 1202, 1204, 1206, 1208, 1210, 1214, 1216, 1218, and 1222, respectively, of FIG. 12A, and may include plain text. “Planet” object 1236 may include an advertisement for a discount on coffee and may also include plain text. Another advertisement 1244 may include bolded text inviting the viewer to buy the sixth season of “Friends” on DVD. The bolded text in advertisement 1244 may be darker, and thus draw more attention, than the text in other media objects that appear in display screen 1225. In some embodiments, advertisement 1244 may be visually distinguished because it is associated with a higher rank than other displayed advertisements. The relationship between an advertisement's associated rank and the way the advertisement is displayed is discussed further below in relation to FIG. 14A.

In some embodiments, the text of a visually distinguished object may appear in block letters or another font different from that of the text in other displayed media objects. In some embodiments, the text of a visually distinguished media object may appear in a different color than other displayed text. In some embodiments, the text of a visually distinguished media object may appear bigger or closer to the viewer than other displayed text. In some embodiments, the text of a visually distinguished media object may scroll inside the media object.

In some embodiments, a media object may be visually distinguished by a border around the media object, as shown in display screen 1250 of FIG. 12C. Media objects 1252, 1254, 1256, 1258, 1260, 1264, 1266, 1268, 1270, and 1272 of FIG. 12C correspond to media objects 1202, 1204, 1206, 1208, 1210, 1214, 1216, 1218, 1220, and 1222, respectively, of FIG. 12A. Media object 1262 in FIG. 12C may include an advertisement for a discount on coffee. Media object 1262 may be visually distinguished from other media objects in display screen 1250 by border 1274. In some embodiments, media object 1262 may be visually distinguished because processing circuitry 306 has determined that media object 1262 is associated with a higher rank than other media objects in display screen 1250.

In some embodiments, border 1274 may flash in one or more colors. For example, border 1274 may appear on the screen in blue, then temporarily disappear and quickly reappear in red, then temporarily disappear and quickly reappear in green. The cycle of border 1274 disappearing and reappearing in a different color may continue indefinitely. Other colors may be used in the cycle, and the cycle may involve more than three colors or less than three colors. In some embodiments, the order of colors of border 1274 may be randomized, and some colors may appear more often or for a longer time than other colors. In some embodiments, border 1274 may be animated to rotate around media object 1262.

In some embodiments, the background between media object 1262 and border 1274 may be a different color than the background in the rest of display screen 1250. In some embodiments, the background between media object 1262 and border 1274 may change colors over time. For example, the background between media object 1262 and border 1274 may appear orange for a second, then yellow for the next second, then back to orange, and continue cycling between the colors indefinitely. Other colors may be used in the cycle, and the cycle may involve more than two colors. In some embodiments, the order of colors of the background between media object 1262 and border 1274 may be randomized, and some colors may appear more often or for a longer time than other colors.

In some embodiments, a media object may be visually distinguished by a displayed message on the screen about the media object, as shown in display screen 1275 of FIG. 12D. Media objects 1276, 1278, 1280, 1282, 1284, 1288, 1290, 1292, 1294, and 1296 of FIG. 12D correspond to media objects 1202, 1204, 1206, 1208, 1210, 1214, 1216, 1218, 1220, and 1222, respectively, of FIG. 12A. Media object 1286 in FIG. 12D may include an advertisement for a discount on coffee. Media object 1286 may be visually distinguished from other media objects in display screen 1275 by displayed message 1298 that directs a viewer's attention to media object 1286. In some embodiments, media object 1286 may be visually distinguished because processing circuitry 306 has determined that media object 1286 is associated with a higher rank than other media objects in display screen 1275.

In some embodiments, displayed message 1298 may appear adjacent to visually distinguished media object 1286. In other embodiments, displayed message 1298 may scroll across display screen 1275. In some embodiments, displayed message 1298 may include an arrow or pointer that indicates which media object displayed message 1298 refers to. In some embodiments, displayed message 1298 may appear in a different color or a different font than other text in display screen 1275. In some embodiments, displayed message 1298 may be animated. For example, displayed message 1298 may blink repeatedly in one or more colors in display screen 1275 or move around visually distinguished media object 1286.

It should be understood that any of the media objects that appear in display screens 1200, 1225, 1250, and 1275 may be visually distinguished in any of the manners discussed above in relation to FIGS. 12A-D. More than one media object may be visually distinguished at the same time, and different media objects may be visually distinguished in different ways. For example, media object 1204 in FIG. 12A may be visually distinguished with a highlight region, and media object 1220 in FIG. 12A may be visually distinguished with bolded text.

It should be understood that the size of the media objects shown in FIGS. 7A-B, 10, and 12A-D represent different locations of the media objects in 3D space. For example, the size of a circle represents how close or far from the viewer a selectable media guidance object appears to be when viewed with a stereoscopic optical device. In particular, the larger the size of the circle, the closer to the viewer the selectable media guidance object appears to be and the smaller the size of the circle, the farther away from the user the selectable media guidance object appears to be. For example, selectable media guidance object 752 in FIG. 7B appears closer to the viewer when viewed with the stereoscopic optical device than selectable media guidance object 760 which is drawn to be smaller in size.

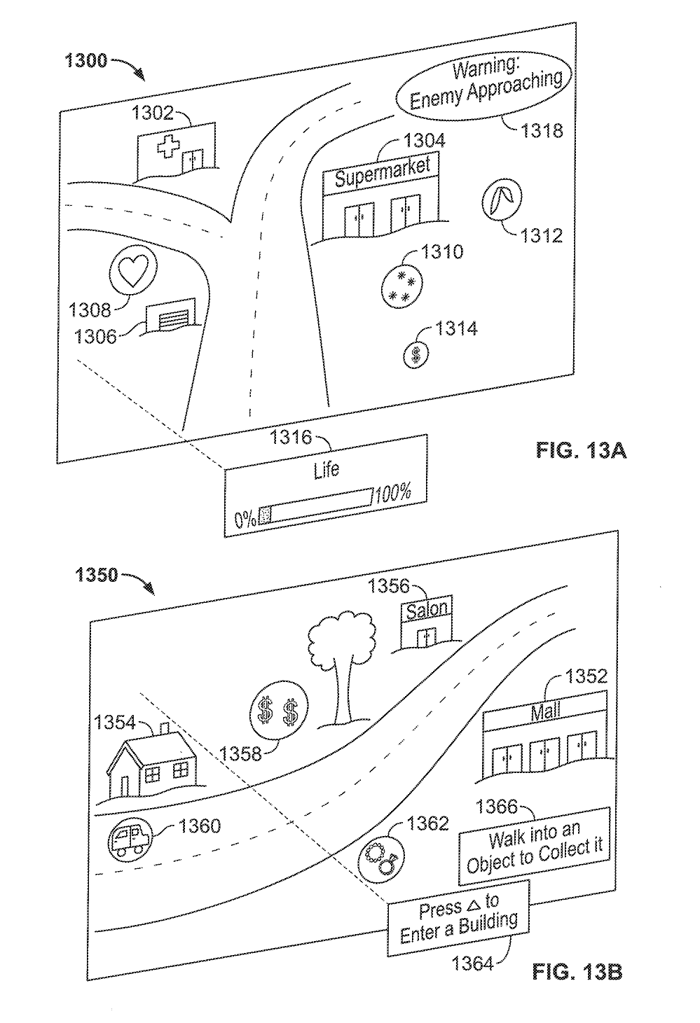

FIGS. 7A-12D discussed above relate to a stereoscopic media environment that is a stereoscopic media guidance application. In some embodiments, a stereoscopic media environment may be a videogame environment. FIG. 13A shows an illustrative display screen 1300 of a stereoscopic videogame environment in accordance with an embodiment of the invention.

Display screen 1300 may be a scene from a videogame in which a viewer controls an avatar. The avatar may defend his territory from enemy invaders. The avatar may be able to enter various buildings, represented by media objects 1302, 1304, and 1306, to help him survive and fight off invaders. For example, the avatar may be injured during a fight and may enter hospital 1302 to obtain medication and treatment. The avatar may enter supermarket 1304 to buy food to stay alive. The avatar may enter warehouse 1306 to search for needed tools or a vehicle for transportation.

Buildings 1302, 1304, and 1306 may appear in different sizes to or at different distances from the viewer in the stereoscopic videogame environment. In some embodiments, the appearances of the buildings in display screen 1300 may be situation dependent. For example, if the avatar has been severely injured in a fight, hospital 1302 may appear very close to the viewer to indicate that the avatar should seek medical attention immediately. If the avatar has not eaten in a long time, supermarket 1304 may appear very large in display screen 1300. The size or apparent distance of the buildings may help the viewer prioritize the order in which the avatar should visit the buildings.

Media objects 1308, 1310, 1312, and 1314 in display screen 1300 may represent collectible objects that will help the avatar. Collectible object 1308 may represent an extra life for the avatar, or may restore the avatar to full health. Collectible object 1310 may represent a special ability, such as invincibility or invisibility, that may help the avatar fight more effectively against invaders. Collectible object 1312 may represent a weapon, such as a knife, that the avatar may add to his arsenal. Collectible object 1314 may represent money that the avatar may use to pay for food, supplies, weapons, or medical care.

Collectible objects 1308, 1310, 1312, and 1314 may appear in different sizes to or at different distances from the viewer in the stereoscopic videogame environment. In some embodiments, the appearances of the collectible objects in display screen 1300 may be situation dependent. For example, if the avatar has very little life left, collectible object 1308 may appear very close to the viewer to draw the viewer's attention to restoring the avatar's life. If an enemy is approaching and the avatar has no weapons, collectible object 1312 may appear very large in display screen 1300. The size or apparent distance of the collectible objects may help the viewer prioritize the order in which the avatar should collect the collectible objects.

Media objects 1316 and 1318 in display screen 1300 may represent warnings to the viewer about the current situation in the videogame. Warning 1316 may include a “life indicator” for the avatar alerting the viewer that the avatar is not strong enough at the moment to engage in a battle. Seeing warning 1316 may encourage the viewer to move the avatar toward a hospital or a collectible object that will restore the avatar's life. Warning 1318 may inform the viewer that an enemy is approaching. Seeing warning 1316 may encourage the viewer to obtain a weapon for the avatar or prepare for a battle.

Warnings 1316 and 1318 may appear in different sizes to or at different distances from the viewer in the stereoscopic videogame environment. In some embodiments, the appearances of the warnings in display screen 1300 may be situation dependent. For example, if the avatar has very little life left, warning 1316 may appear very close to the viewer to draw the viewer's attention to restoring the avatar's life. If the avatar's “life indicator” is slightly below half of the maximum, warning 1316 may appear smaller or farther away from the viewer because the avatar's condition is not as precarious. If an enemy is approaching but is still far away from the avatar's current position, warning 1318 may appear far away from the viewer. If an enemy is about to appear on display screen 1300, warning 1318 may appear very close to the viewer, especially if the avatar does not have any weapons. The size or apparent distance of the warnings may help the viewer prioritize the order in which the warnings should be heeded.

In some embodiments, each media object may be associated with a rank based on the importance of the media object to the avatar. The relationship between the associated rank of a media object and the appearance of the media object in a display screen is discussed below in relation to FIGS. 14A-C. In some embodiments, one or more of the media objects may be visually distinguished based on rank in a manner discussed above in relation to FIGS. 12A-D.

FIG. 13B shows an illustrative display screen of a stereoscopic videogame environment in accordance with another embodiment of the invention. Display screen 1350 may be a scene from a videogame in which the viewer controls an avatar that is a celebrity. The viewer's goal may be to improve the avatar's appearance and social status as much as possible. The avatar may be able to enter various buildings, represented by media objects 1352, 1354, and 1356. The avatar may enter mall 1352 to shop for new clothes and accessories. The avatar may return to her home 1354 to change her clothes and get ready for an event. The avatar may enter salon 1356 to get a beauty treatment.

Buildings 1352, 1354, and 1356 may appear in different sizes to or at different distances from the viewer in the stereoscopic videogame environment. In some embodiments, the appearances of the buildings in display screen 1350 may be situation dependent. For example, if the avatar is hosting a party, mall 1352 may appear very close to the viewer to indicate that the avatar should shop for decorations and items for gift bags. If the avatar will be interviewed on a talk show, salon 1356 may appear very large in display screen 1350 because the avatar may want to have her hair styled for the interview. The size or apparent distance of the buildings may help the viewer prioritize the order in which the avatar should visit the buildings.

Media objects 1358, 1360, and 1362 in display screen 1350 may represent collectible objects that will help the avatar. Collectible object 1358 may represent money that the avatar may use to pay for clothes, accessories, gifts, and beauty treatments. Collectible object 1360 may represent a new car that the avatar may use to travel from place to place. Collectible object 1362 may jewelry that the avatar may wear to enhance her appearance.

Collectible objects 1358, 1360, and 1362 may appear in different sizes to or at different distances from the viewer in the stereoscopic videogame environment. In some embodiments, the appearances of the collectible objects in display screen 1350 may be situation dependent. For example, if the avatar has just spent a lot of money while shopping, collectible object 1358 may appear very close to the viewer to draw the viewer's attention to replenishing the avatar's bank account. If the avatar has recently bought a lot of new jewelry, collectible object 1362 may appear smaller than other collectible objects in display screen 1350 because the avatar does not need more jewelry at the moment. The size or apparent distance of the collectible objects may help the viewer prioritize the order in which the avatar should collect the collectible objects.

Media objects 1364 and 1366 in display screen 1350 may represent instructions to the viewer about how to play the videogame. Instruction 1364 may inform the viewer about what button on a user input device to press to allow the avatar to enter a building. Instruction 1366 may inform the viewer that a collectible object may be collected by having the avatar walk into the collectible object. In some embodiments, instructions 1364 and 1366 may give the viewer information about the next location to which the avatar should go, or describe the benefits of a certain collectible object.

Instructions 1364 and 1366 may appear in different sizes to or at different distances from the viewer in the stereoscopic videogame environment. In some embodiments, the appearances of the instructions in display screen 1350 may be situation dependent. For example, if the avatar keeps walking past the same buildings without entering them, instruction 1364 may appear very close to the viewer to let the viewer know how to have the avatar enter a building. If the viewer has already collected some collectible objects for the avatar, instruction 1366 may appear smaller or farther away from the viewer because the viewer has already demonstrated knowledge about how to collect collectible objects. The size or apparent distance of the instructions may help the viewer prioritize the order in which the instructions should be followed.

In some embodiments, each media object may be associated with a rank based on the importance of the media object to the avatar. Processing circuitry 306 may determine that the media objects have associated respective ranks and may display the media objects at different apparent distances using the procedure described above in relation to FIGS. 6A-B. The relationship between the associated rank of a media object and the appearance of the media object in a display screen is discussed below in relation to FIGS. 14A-C. In some embodiments, one or more of the media objects may be visually distinguished based on rank in a manner discussed above in relation to FIGS. 12A-D.

FIGS. 14A-C show various illustrative rankings of media objects in accordance with various embodiments of the invention. The rankings in FIG. 14A are organized in table 1400, which may include sponsor column 1402, contribution column 1404, and rank column 1406. Sponsors 1408, 1410, 1412, 1414, and 1416 under sponsor column 1402 may include sponsors associated with various advertisements that appear in display screen 1000, discussed above in relation to FIG. 10. In particular, advertisement 1014 may be associated with sponsor 1412, Home Depot. Advertisement 1016 may be associated with sponsor 1414, Consumer Reports. Advertisement 1024 may be associated with sponsor 1410, Fandango. Advertisement 1022 may be associated with sponsor 1408, Amazon.com. Advertisement 1026 may be associated with sponsor 1416, which may also be Amazon.com. Each advertisement may promote a product that its associated sponsor sells. Sponsors 1408, 1410, 1412, 1414, and 1416 may have contributed monetary amounts 1418, 1420, 1422, 1424, and 1426, respectively, for their respective advertisements. The contributed amounts may be listed under contribution column 1404 of table 1400. Sponsors 1408, 1410, 1412, 1414, and 1416 may also have associated ranks 1428, 1430, 1432, 1434, and 1436, respectively, that may be listed under rank column 1406 of table 1400.

In table 1400, ranks are associated with sponsors based on the amount of monetary contributions that the sponsors make. Sponsors who make higher contributions are ranked higher. For example, Amazon.com contributed $2000.00 for advertisement 1022, which was more than any other sponsor contributed for its respective advertisement. Therefore, Amazon.com is ranked first in table 1400.

A sponsor's rank may be related to the way the sponsor's advertisement is displayed in a stereoscopic media environment. In some embodiments, processing circuitry 306 may display advertisements associated with higher ranked sponsors at apparent distances closer to the viewer than advertisements associated with lower ranked sponsors. For example, Home Depot is ranked higher than Consumer Reports in table 1400, so processing circuitry 306 may generate images for display screen 1000 using the procedure described above in relation to FIGS. 6A-B, such that Home Depot's advertisement 1014 appears closer to the viewer than Consumer Reports's advertisement 1016. Processing circuitry 306 may display higher-ranked advertisements more prominently than lower-ranked advertisements using other techniques. In some embodiments, advertisements associated with higher ranked sponsors may appear larger than advertisements associated with lower ranked sponsors. For example, Amazon.com is ranked higher than Fandango in table 1400, so Amazon.com's advertisement 1022 appears larger than Fandango's advertisement 1024 in display screen 1000. In some embodiments, an advertisement with a high rank may be visually distinguished from other advertisements. For example, since Amazon.com is the highest-ranked sponsor, the text in advertisement 1022 may be bolded, or advertisement 1022 may be surrounded by a border that changes color.

It should be understood that the amount of money a sponsor contributes is not the only criterion by which to rank an advertisement or associated sponsor. In some embodiments, a sponsor or an associated advertisement may be ranked highly because the sponsor or associated advertisement is highly relevant to another displayed media object. For example, advertisement 1022 may have a higher associated rank, and thus appear closer to the viewer, than advertisement 1014 in display screen 1000 because buying movie DVDs is more relevant to the displayed media objects than a website for do-it-yourself home projects.

It should also be understood that any type of media object, not just advertisements, may be associated with a ranking. In some embodiments, rankings may be associated with the “planet” objects in FIG. 10 that include recommended content. The rankings may be based on how relevant the recommended content is to the viewer's viewing history, or how many other viewers recommended the content. In some embodiments, rankings may be associated with media objects in a stereoscopic videogame environment, as discussed below in relation to FIGS. 14B-C.

The rankings in FIG. 14B are organized in table 1450, which may include object column 1452 and rank column 1454. Object descriptors 1456, 1458, 1460, and 1462 may be listed under object column 1452 and may correspond to various collectible objects that appear in display screen 1300, discussed above in relation to FIG. 13A. In particular, object descriptor 1456, Life, may correspond to collectible object 1308. Object descriptor 1458, Invincibility, may correspond to collectible object 1310. Object descriptor 1460, Knife, may correspond to collectible object 1312. Object descriptor 1462, Money, may correspond to collectible object 1314. Object descriptors 1456, 1458, 1460, and 1462 may have associated ranks 1464, 1466, 1468, and 1470, respectively, that may be listed under rank column 1454 of table 1450.

In table 1450, ranks may be associated with object descriptors based on the importance of the respective collectible objects to the avatar in the current situation. Object descriptors of collectible objects that are more important to the avatar are ranked higher. For example, in the situation illustrated in display screen 1300, the avatar has very little life left. The most important collectible objects to the avatar in this situation are objects that increase or preserve the avatar's life. Therefore, Life is ranked first in table 1450, since collecting collectible object 1308 will restore the avatar's life completely. Invincibility is ranked second in table 1450, since with invincibility the avatar's life will not decrease if he is attacked by an enemy. Knife and Money are ranked lower in table 1450 since having weapons and money will not directly affect the amount of life the avatar has.

An object descriptor's rank may be related to the way the corresponding collectible object is displayed in a stereoscopic videogame environment. In some embodiments, processing circuitry 306 may display collectible objects corresponding to higher ranked object descriptors closer to the viewer than collectible objects associated with lower ranked object descriptors. For example, Invincibility is ranked higher than Knife in table 1450, so processing circuitry 306 may generate images for display screen 1300 using the procedure described above in relation to FIGS. 6A-B, such that collectible object 1310 appears closer to the viewer than collectible object 1312. In some embodiments, processing circuitry 306 may display collectible objects corresponding to higher ranked object descriptors larger than collectible objects corresponding to lower ranked object descriptors. For example, Life is ranked higher than Money in table 1450, so collectible object 1308 appears larger than collectible object 1314 in display screen 1300. In some embodiments, a collectible object corresponding to an object descriptor with a high rank may be visually distinguished from other collectible objects. For example, since Life is the highest-ranked object descriptor, collectible object 1308 may be surrounded by a border that changes color.

It should be understood that the rankings in table 1450 may change when the situation in the stereoscopic videogame environment changes. For example, if the avatar has close to maximum life but does not have any weapons, Knife may be ranked higher than Life in table 1450, and the appearance of the corresponding collectible objects in display screen 1300 may change accordingly. In this situation, processing circuitry 306 may generate images for display screen 1300 such that collectible object 1312 appears larger or closer to the viewer than collectible object 1308.

The rankings in FIG. 14C are organized in table 1475, which may include location column 1476 and rank column 1478. Location descriptors 1480, 1482, 1484, and 1486 may be listed under location column 1476 and may correspond to various locations that appear in display screen 1350, discussed above in relation to FIG. 13B. In particular, location descriptor 1480, Mall, may correspond to location 1352. Location descriptor 1482, Home, may correspond to location 1354. Location descriptor 1484, Salon, may correspond to location 1356. Location descriptor 1486, Restaurant, may correspond to a location that is not shown in display screen 1350. Location descriptors 1480, 1482, 1484, and 1486 may have associated ranks 1488, 1490, 1492, and 1494, respectively, that may be listed under rank column 1478 of table 1475.

In table 1475, ranks may be associated with location descriptors based on the importance of the respective locations to the avatar in the current situation. Location descriptors of locations that are more important to the avatar are ranked higher. For example, in the situation illustrated in display screen 1350, the avatar may be preparing to host a costume party in her home for her friends. The most important locations to the avatar in this situation are locations that the avatar must go to for her preparations. Therefore, Mall is ranked first in table 1475, since the avatar must buy decorations for her house and materials for her costume. Home is ranked second in table 1475, since the avatar will be bringing her purchases back to her home to prepare for the party. Salon is ranked third in table 1475, since beauty treatments may not be crucial to the avatar's preparations. Restaurant is ranked fourth in table 1475, since the avatar will not be going out to eat while she prepares for the party.

A location descriptor's rank may be related to the way the corresponding location is displayed in a stereoscopic videogame environment. In some embodiments, processing circuitry 306 may display locations corresponding to higher ranked location descriptors closer to the viewer than locations associated with lower ranked location descriptors. For example, Mall is ranked higher than House in table 1475, so processing circuitry 306 may generate images for display screen 1350 using the procedure described above in relation to FIGS. 6A-B, such that location 1352 appears closer to the viewer than location 1354. In some embodiments, processing circuitry 306 may display locations corresponding to higher ranked location descriptors larger than locations corresponding to lower ranked location descriptors. For example, House is ranked higher than Salon in table 1475, so location 1354 appears larger than location 1356 in display screen 1350. In some embodiments, a location corresponding to an location descriptor with a high rank may be visually distinguished from other locations. For example, all media objects in display screen 1350 may be displayed in pastel colors except for location 1352, which may be displayed in bold colors since Mall is the highest-ranked location descriptor.

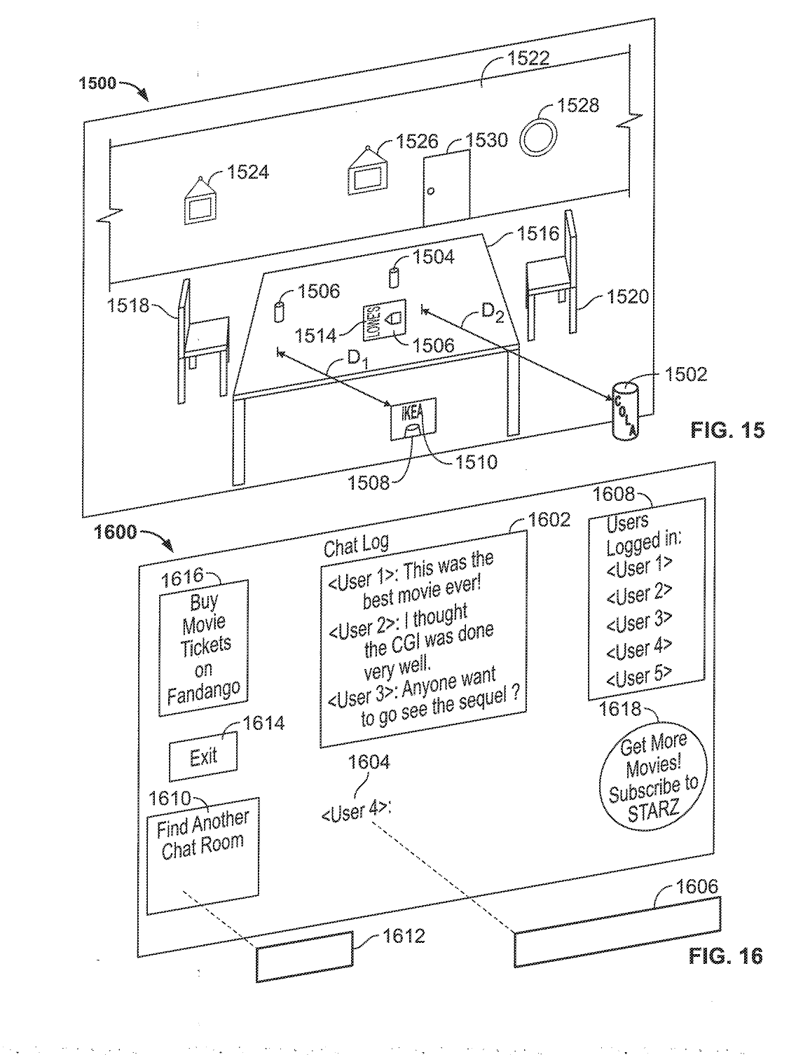

FIG. 15 shows an illustrative scene 1500 from a stereoscopic media asset in accordance with an embodiment of the invention. In some embodiments, scene 1500 may be a scene of a dining area from a television sitcom. In other embodiments, scene 1500 may be a scene from a movie, music video, or shopping application. The dining area may include table 1516 and chairs 1518 and 1520. Objects 1502, 1504, 1506, 1508, and 1512 may appear on table 1516 as ordinary scene objects or as media objects that are part of a product placement campaign. For example, objects 1504 and 1506 may be ordinary scene objects that are soda cans. Object 1502 may be a soda can media object that appears in scene 1500 as part of a product placement campaign for a brand of soda, Cola. The manufacturer of Cola may have made a monetary contribution to have cans of Cola brand soda appear more prominent in scenes than other soda cans. In some embodiments, can of Cola 1502 may appear larger in scene 1500 than other soda cans 1504 and 1506, and the Cola brand name may be clearly visible to a viewer. In some embodiments, can of Cola 1502 may appear closer to the viewer than other soda cans 1504 and 1506. For example, processing circuitry 306 may generate images for scene 1500 such that can of Cola 1502 appears at a distance D2 closer to the viewer than other soda cans 1504 and 1506. In some embodiments, can of Cola 1502 may be visually distinguished from other objects. For example, can of Cola 1502 may have bolder lines and colors than other objects in scene 1500, or may be surrounded by a border or highlight region.

Objects 1508 and 1512 may be catalog media objects that appear in scene 1500 as part of product placement campaigns for their respective sponsors, Ikea and Lowe's. The sponsors' names may appear on catalog media objects 1508 and 1512 as text objects 1510 and 1514, respectively. Catalog media objects 1508 and 1512 and their respective sponsors may be associated with rankings in the manner described above in relation to FIG. 14A. For example, Ikea may have made a higher monetary contribution than Lowe's, so Ikea may be associated with a higher rank than Lowe's. In some embodiments, processing circuitry 306 may generate images for scene 1500 using the procedure described above in relation to FIGS. 6A-B, such that catalog media object 1508, which is associated with Ikea, appears closer to the viewer than catalog media object 1512, which is associated with Lowe's. For example, processing circuitry 306 may generate images for scene 1500 such that catalog media object 1508 appears at a distance D1 closer to the viewer than catalog media object 1512. In some embodiments, catalog media object 1508 may appear larger than catalog media object 1512 in scene 1500. In some embodiments, catalog media object 1508 may be visually distinguished from catalog media object 1512. For example, text object 1510 in catalog media object 1508 may appear larger or bolder than text object 1514 in catalog media object 1512. Catalog media object 1508 may appear in bolder colors than catalog media object 1512 or be surrounded by a border or highlight region.

In some embodiments, objects 1524, 1526, and 1528 on wall 1522 may also be media objects. In some embodiments, media objects 1524, 1526, and 1528 may include illustrations of products associated with one or more sponsors. In some embodiments, media objects 1524, 1526, and 1528 may include text, such as slogans or special offers, associated with one or more sponsors. The text may be animated, such as scrolling across one of media objects 1524, 1526, and 1528, or may be still. In some embodiments, the sponsors associated with media objects 1524, 1526, and 1528 may have associated ranks based on monetary contributions from each sponsor. Based on the associated ranks, processing circuitry 306 may generate images for scene 1500 using the procedure described above in relation to FIGS. 6A-B, such that media objects 1524, 1526, and 1528 may appear at different distances from the viewer or be different sizes. In some embodiments, one or more of media objects 1524, 1526, and 1528 may be visually distinguished from other media objects in scene 1500 in a manner discussed above in relation to FIGS. 12A-D.

In some embodiments, one or more of media objects 1502, 1508, 1512, 1524, 1526, and 1528 may be selectable. In some embodiments, selecting one of media objects 1502, 1508, 1512, 1524, 1526, and 1528 may cause additional information about the associated sponsor to be displayed in a manner discussed above in relation to FIGS. 9A-B and 11. The additional information may include general information about the associated sponsor or specific information about the product represented by the selected media object. In some embodiments, selecting one of media objects 1502, 1508, 1512, 1524, 1526, and 1528 may activate an interactive application related to the selected media object. For example, a link to the associated sponsor's internet home page may be activated, or a shopping application may be opened that the viewer can use to purchase items related to the selected media object and the associated sponsor.

In some embodiments, a stereoscopic media environment may be a chat room environment. FIG. 16 shows an illustrative display screen 1600 of a stereoscopic chat room environment in accordance with an embodiment of the invention. A viewer may enter a chat room to chat with other viewers about a movie the viewer has recently watched. Chat room display screen 1600 may include chat log 1602, which may display the comments of all chat room participants. Viewer chat room username 1604 may be displayed above text entry box 1606, a media object in which the user may enter text to communicate with other chat room participants. Display screen 1600 may include list of current chat room users 1608. Media object 1610 may allow the viewer to find another chat room by typing a chat room topic into text entry box 1612, another media object in which the user may enter text. The viewer may exit the chat room by selecting exit media object 1614.

Text entry boxes 1606 and 1612 may be displayed more prominently than other media objects in display screen 1600 to draw the viewer's attention to regions where the viewer may enter text. In some embodiments, the boundaries of text entry boxes 1606 and 1612 may be appear in bolder lines than the lines of other media objects in display screen 1600. In some embodiments, text entry boxes 1606 and 1612 may be associated with respective ranks, and processing circuitry 306 may generate images for display screen 1600 using the procedure described above in relation to FIGS. 6A-B, such that text entry boxes 1606 and 1612 appear closer to the viewer than other media objects.

In some embodiments, media objects 1616 and 1618 may appear in display screen 1600. Media objects 1616 and 1618 may include advertisements associated with one or more sponsors. In some embodiments, one or both of advertisements 1616 and 1618 may be related to the topic of the chat room. For example, if the topic of the chat room is a movie, advertisement 1616 may be associated with Fandango (an internet website with information about movie showtimes and tickets), and advertisement 1618 may be associated with STARZ (a subscription channel that shows a lot of movies). In some embodiments, the sponsors may have associated ranks based on criteria like amount of monetary contributions and relevance to the chat room topic. For example, STARZ may be ranked higher than Fandango because STARZ made a higher monetary contribution than Fandango. As a result, processing circuitry 306 may generate images for display 1600 using the procedure described above in relation to FIGS. 6A-B, such that advertisement 1618 appears closer to the viewer or larger than advertisement 1616.

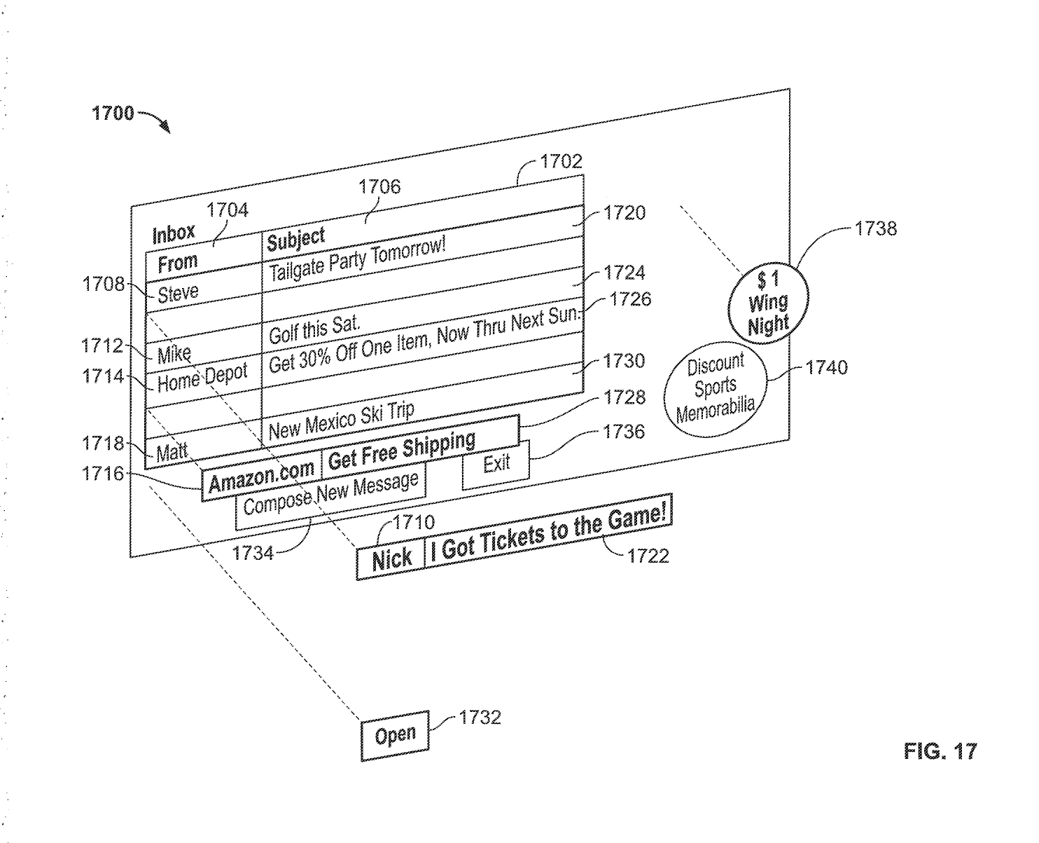

In some embodiments, a stereoscopic media environment may be an electronic mail client. FIG. 17 shows an illustrative display screen 1700 of a stereoscopic e-mail client environment in accordance with an embodiment of the invention. Display screen 1700 may include a sender column 1704 and a subject column 1706. Names of various senders 1708, 1710, 1712, 1714, 1716, and 1718 may appear in sender column 1704. Various message subjects 1720, 1722, 1724, 1726, 1728, and 1730 corresponding to respective senders 1709, 1710, 1712, 1714, and 1716 may appear in subject column 1706. A viewer may open an electronic message by selecting the corresponding sender or message subject and then selecting media object 1732. A viewer may compose a new electronic message by selecting media object 1734. To exit the electronic mail client, a viewer may select media object 1736.

In some embodiments, media objects 1732, 1734, and 1736 may all appear at the same distance from the viewer. In other embodiments, media objects 1732, 1734, and 1736 may have associated ranks and may appear at different distances from the viewer. For example, media object 1732 may be ranked higher and appear closer to the viewer than media objects 1734 and 1736 because the user is primarily concerned with viewing received messages. Processing circuitry 306 may generate images for display screen 1700 using the procedure described above in relation to FIGS. 6A-B, such that media objects 1732, 1734, and 1736 appear at appropriate relative distances from the viewer. In some embodiments, one or more of media objects 1732, 1734, and 1736 may be visually distinguished. For example, the text and boundaries of media object 1732 may appear bolder than the text and boundaries of other media objects in display screen 1700.

In some embodiments, certain senders and their corresponding message subjects may appear more prominent than other senders and corresponding message subjects in display screen 1700. For example, sender name 1710 and message subject 1722 corresponding to a message sent with high importance may appear closer to the viewer than other sender names and message subjects. A sponsor, such as Amazon.com, may send advertisements to viewers via electronic mail and may make a monetary contribution to have its name 1716 and message subject 1728 be visually distinguished (e.g. appear in bolder lines and text) from those of other sponsors. In some embodiments, incoming messages may be assigned respective ranks based on criteria such as familiarity of the viewer with the sender, subject matter, and amount of monetary contribution from the associated sponsor. A message's rank may be related to the way its corresponding sender name and message subject is displayed in the stereoscopic electronic mail client environment. Processing circuitry 306 may determine that certain messages have associated ranks and may generate images for display screen 1700 using the procedure described above in relation to FIGS. 6A-B, such that the message senders and subjects appear at appropriate relative distances from the viewer.

In some embodiments, media objects 1738 and 1740 may appear in display screen 1700. Media objects 1738 and 1740 may include advertisements associated with one or more sponsors. In some embodiments, one or both of advertisements 1738 and 1740 may be related to one or more message subjects in display screen 1700. In some embodiments, advertisements 1738 and 1740 may not be related to any message subjects in display screen 1700. In some embodiments, the sponsors may have associated ranks based on criteria like amount of monetary contributions and relevance to displayed message subjects. For example, the sponsor associated with advertisement 1738 may be ranked higher than the sponsor associated with advertisement 1740 because the sponsor associated with advertisement 1738 made a higher monetary contribution. As a result, processing circuitry 306 may generate images for display screen 1700 using the procedure described above in relation to FIGS. 6A-B, such that advertisement 1738 appears closer to the viewer or larger than advertisement 1740.

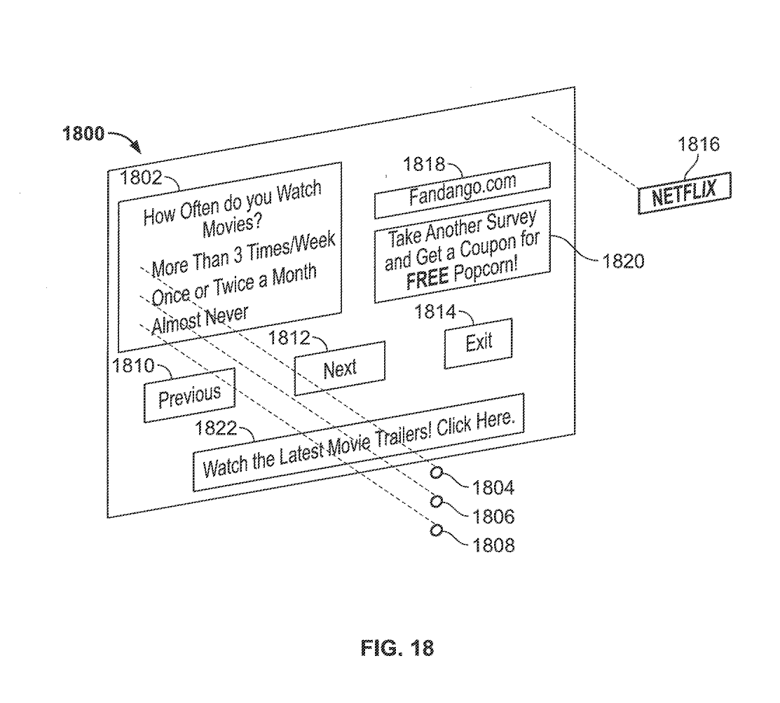

In some embodiments, a stereoscopic media environment may be a survey environment. FIG. 18 shows an illustrative display screen 1800 of a stereoscopic survey environment in accordance with an embodiment of the invention. Display screen 1800 may include a survey media object 1802 and navigation media objects 1810, 1812, and 1814. The topic of the survey may be “Movies”. Survey media object 1802 may include a question about movies and options that a viewer may select for an answer. The viewer may respond to the question by selecting one of option bubble media objects 1804, 1806, and 1808 with a user input device. In some embodiments, option bubbles 1804, 1806, and 1808 may appear more prominent in display screen 1800 than other media objects to draw the viewer's attention to the regions for viewer input. For example, option bubbles 1804, 1806, and 1808 may appear closer to the viewer than other media objects in display screen 1800.

Viewer selection of navigation media object 1810 may allow the viewer to view the previous question in the survey. Viewer selection of navigation media object 1812 may allow the viewer to view the next question in the survey. Viewer selection of navigation media object 1814 may allow the viewer to exit the survey. In some embodiments, navigation media objects 1810, 1812, and 1814 may all appear at the same distance from the viewer. In some embodiments, navigation media objects 1810, 1812, and 1814 may appear at different distances from the viewer depending on how far along the viewer is in the survey. For example, if the viewer is on the first question of the survey, navigation media object 1812 may appear closer to the viewer than navigation media objects 1810 and 1814 to indicate to the viewer that there are more questions in the survey.

In some embodiments, media objects 1816, 1818, 1820, and 1822 may appear in display screen 1800. Media objects 1816, 1818, 1820, and 1822 may include advertisements associated with one or more sponsors. In some embodiments, one or more of advertisements 1816, 1818, 1820, and 1822 may be related to the topic of the survey. For example, if the topic of the chat room is “Movies”, advertisement 1816 may be associated with Netflix (a movie rental service), advertisement 1818 may be associated with Fandango (an internet website with information about movie showtimes and tickets), and advertisement 1822 may be associated with a website where viewers can watch movie trailers. Advertisement 1820 may be associated with a survey company and may offer an incentive for the viewer to take another survey, such as a survey about a specific movie or about another topic. In some embodiments, the sponsors may have associated ranks based on criteria like amount of monetary contributions and relevance to the survey topic. For example, Netflix may be ranked higher than Fandango because Netflix made a higher monetary contribution than Fandango. As a result, processing circuitry 306 may generate images for display screen 1800 using the procedure described above in relation to FIGS. 6A-B, such that advertisement 1816 appears closer to the viewer or larger than advertisement 1818.

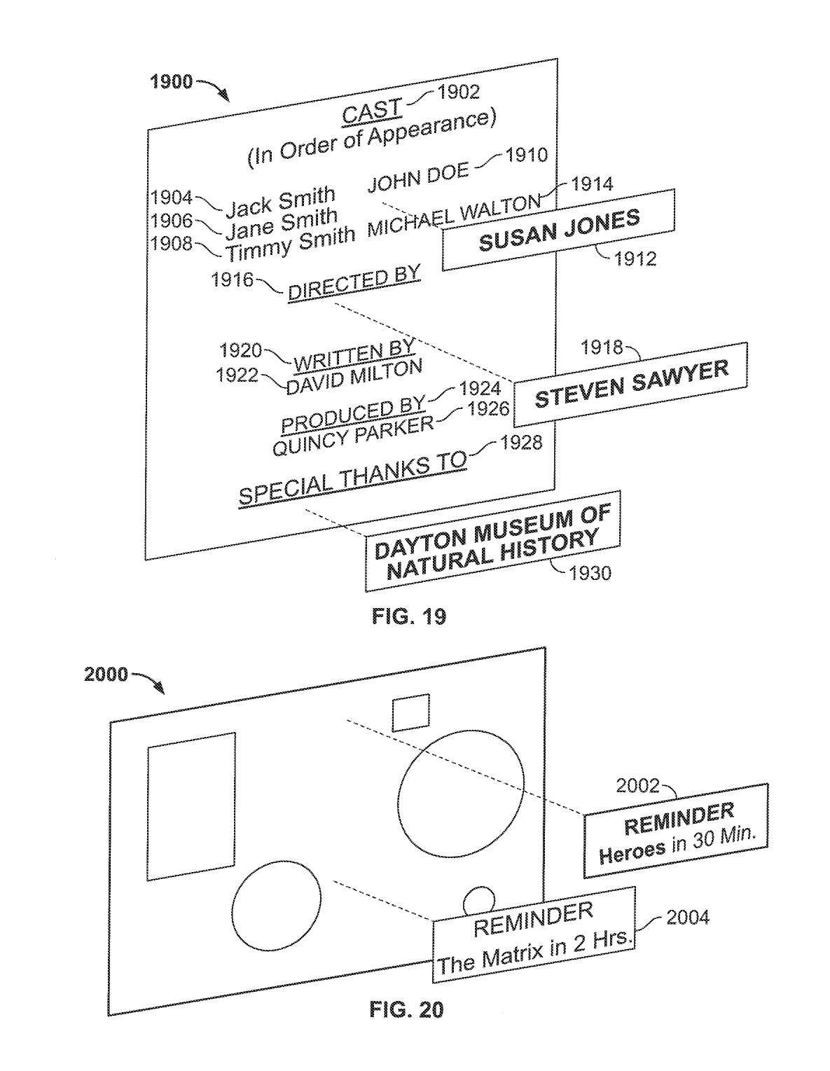

In some embodiments, a stereoscopic media environment may be the credits for a media asset. FIG. 19 shows an illustrative display screen 1900 of credits for a stereoscopic media asset in accordance with an embodiment of the invention. Display screen 1900 may include text media objects associated with cast members and various personnel involved in the production of a movie. Some text objects in display screen 1900 may appear more prominent than other text objects. For example, text object 1912 may be associated with an actress, Susan Jones. Text object 1912 may appear closer to the viewer or in bolder text than the names of other actors in display screen 1900 because Susan Jones is more famous than the other actors or because she has won various awards as an actress.

In some embodiments, display screen 1900 may include text object 1918 associated with the director, Steven Sawyer, of the movie. Text object 1918 may appear more prominent in display screen 1900 than any other text object because Steven Sawyer is more famous or has won more awards than anyone else listed in the credits, or because the fact that Steven Sawyer directed the movie is a big draw for viewers. For example, text object 1918 may appear the closest to the viewer or have the boldest text out of all of the text objects in display screen 1900.

In some embodiments, display screen 1900 may include text object 1930 associated with an organization, the Dayton Museum of Natural History, that assisted in the production of the movie. The organization may be recognized in the credits because it offered expert advice to make the movie more realistic, or because the movie was filmed using the organization's property. Text object 1930 may appear more prominent in display screen 1900 than other text objects to draw the viewer's attention to the organization's contribution. For example, text object 1930 may appear closer to the viewer or in bolder text than other text objects in display screen 1900.

In some embodiments, the text objects in display screen 1900 may have associated ranks based on criteria like fame and importance to the movie. The ranking criteria may be determined, for example, by the movie's producers or by the viewer's personal preferences for certain actors or directors. In one embodiment, the producers may decide that text objects associated with starring actors should be ranked higher than text objects associated with lesser known actors. As a result, processing circuitry 306 may determine that text object 1912 is associated with a higher rank than text object 1914, and may generate images for display screen 1900 using the procedure described above in relation to FIGS. 6A-B, such that the name “Susan Jones” appear closer to the viewer or larger than the name “Michael Walton”.

In some embodiments, media objects that include advertisements may appear in display screen 1900. The advertisements may associated with one or more sponsors. In some embodiments, one or more of advertisements may be related to the genre of the movie, or to movies in general. For example, if the movie is based on a comic book superhero, some advertisements may be sponsored by comic book stores or the manufacturers of action figures. Some advertisements may also be sponsored by, for example, Netflix and Fandango. In some embodiments, the sponsors may have associated ranks based on criteria like amount of monetary contributions and relevance to the movie. Processing circuitry 306 may generate images for display screen 1900 using the procedure described above in relation to FIGS. 6A-B, such that the advertisements appear in the credits at the appropriate relative distances.

In some embodiments, one or more of the media objects in display screen 1900 may be selectable. A viewer selection of, for example, a text object associated with an actor may cause additional information about the actor or the actor's character to appear in the stereoscopic media environment. The additional information may also include other movies or productions in which the actor appears.

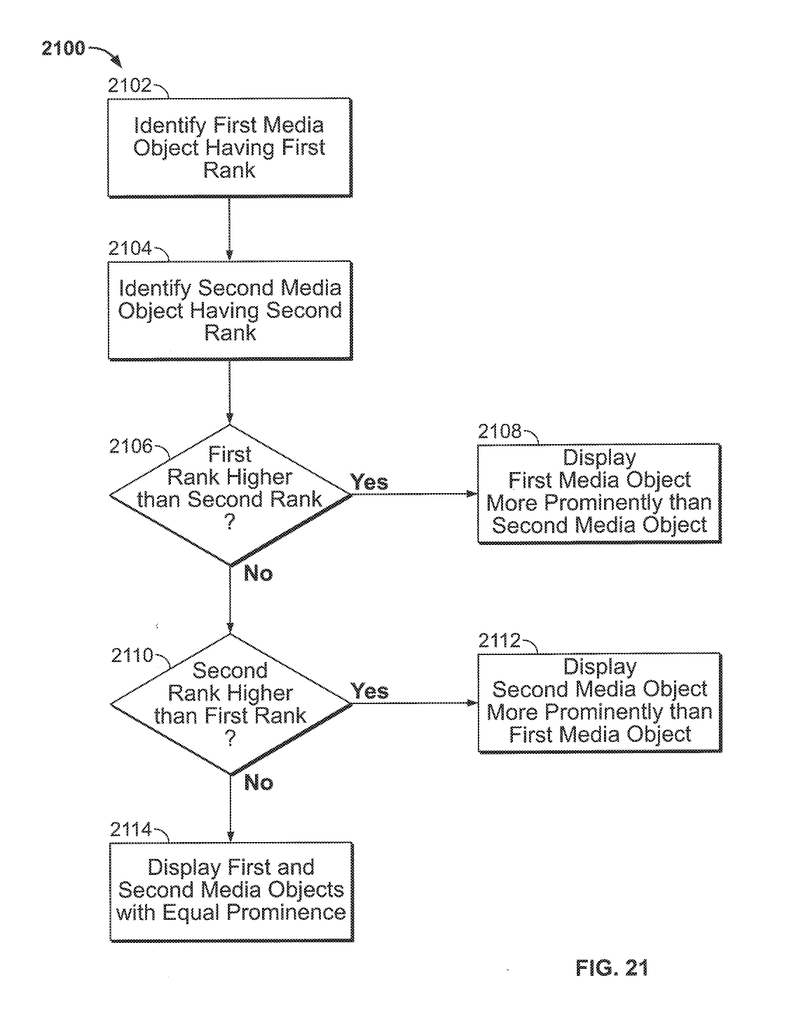

In some embodiments, the viewer may set reminders to watch certain media assets. FIG. 20 shows an illustrative display screen 2000 of reminders for media assets in a stereoscopic media environment in accordance with an embodiment of the invention. Display screen 2000 may include media objects 2002 and 2004. Media object 2002 may include a reminder for the television show “Heroes”. Media object 2004 may include a reminder for the movie “The Matrix”.

In some embodiments, reminder media objects may be associated with ranks. The ranks may be based on criteria such as how soon the media asset associated with a reminder will air and how much a viewer likes a media asset. For example, reminder object 2002 may be associated with a higher rank than reminder object 2004 because “Heroes” will air sooner than “The Matrix”. As a result, processing circuitry 306 may generate images for display screen 2000 using the procedure described above in relation to FIGS. 6A-B, such that reminder object 2002 may appear more prominent than reminder object 2004 in display screen 2000. For example, reminder object 2002 may appear closer to the viewer, larger, or in bolder text than reminder object 2004.

FIG. 21 is an illustrative flow diagram 2100 for relating ranks and prominence of media objects in a stereoscopic media environment in accordance with an embodiment of the invention. At step 2102, a first media object having a first rank may be identified. In some embodiments, processing circuitry 306 may identify a media object having a rank manually associated by a viewer using a user equipment device. In some embodiments, processing circuitry 306 may identify media objects having ranks that are automatically associated based on, for instance, external recommendations, sponsor contributions, the conditions of the stereoscopic media environment, or implied or explicitly stated viewer preferences. For example, processing circuitry 306 may identify collectible object 1308, discussed above in relation to FIG. 13A, having a rank of one because an avatar may be in poor health.

At step 2104, a second media object having a second rank may be identified. For example, processing circuitry 306 may identify collectible object 1312, discussed above in relation to FIG. 13A, having a rank of three because a weapon is not of great importance when the avatar is in poor health.

At step 2106, it is determined whether the first rank is higher than the second rank. For example, processing circuitry 306 may determine that the rank of one associated with collectible object 1308 is higher than the rank of three associated with collectible object 1312. If it is determined at step 2106 that the first rank is higher than the second rank, the process proceeds to step 2108.

At step 2108, the first media object is displayed more prominently than the second media object. For example, processing circuitry 306 may generate images for display screen 1300 using the procedure described above in relation to FIGS. 6A-B, such that object 1308 appears closer to the viewer than object 1312. Alternately, object 1308 may appear in bolder colors than object 1312.

If it is determined at step 2106 that the first rank is not higher than the second rank, the process proceeds to step 2110. At step 2110, it is determined whether the second rank is higher than the first rank. For example, the first rank may be associated with collectible object 1314, which may have an associated rank of four, and the second rank may be associated with collectible object 1312, which may have an associated rank of three. Processing circuitry 306 may determine that a rank of four is not higher than a rank of three. If it is determined at step 2110 that the second rank is higher than the first rank, the process proceeds to step 2112.

At step 2112, the second media object is displayed more prominently than the first media object. For example, processing circuitry 306 may generate images for display screen 1300 using the procedure described above in relation to FIGS. 6A-B, such that object 1312 appears closer to the viewer than object 1314. Alternately, object 1312 may appear in bolder colors than object 1314.

If it is determined at step 2110 that the second rank is not higher than the first rank, the process proceeds to step 2114. At step 2114, the first and second media objects are displayed with equal prominence. For example, a collectible object in FIG. 13A may represent a machete and may be associated with the same rank as collectible object 1312, since the two weapons will be of equal use to the avatar. Processing circuitry may generate images for display screen 1300 such that the collectible object representing the machete appears at the same distance from the viewer as collectible object 1312.

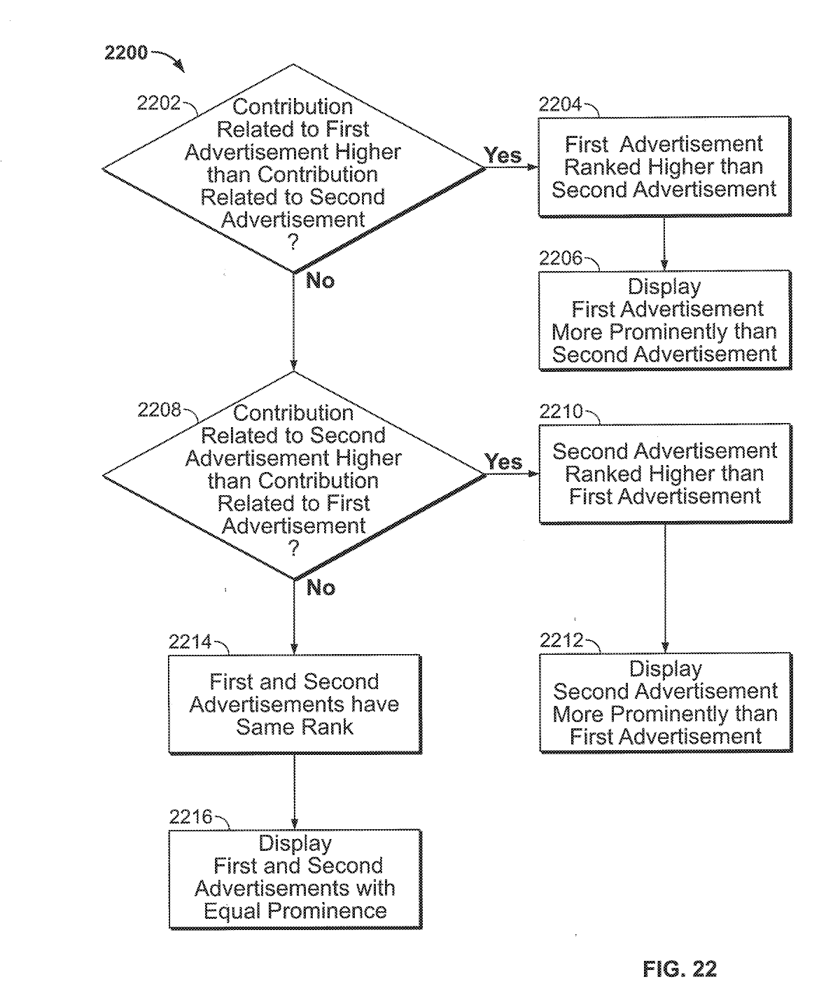

FIG. 22 is an illustrative flow diagram 2200 for relating sponsor contributions, ranks, and prominence of advertisements in accordance with an embodiment of the invention. At step 2202, it is determined whether a contribution related to a first advertisement is higher than a contribution related to a second advertisement. For example, the first advertisement may be Fandango advertisement 1024, and the second advertisement may be Home Depot advertisement 1014, both discussed above in relation to FIG. 10. The contribution related to advertisement 1024 may be $1500.00, and the contribution related to advertisement 1014 may be $800.00. Processing circuitry 306 may determine that the contribution related to advertisement 1024 is higher than the contribution related to advertisement 1014. If it is determined at step 2202 that the contribution related to the first advertisement is higher than the contribution related to the second advertisement, the process proceeds to step 2204.

At step 2204, the first advertisement is ranked higher than the second advertisement. For example, processing circuitry 306 may associate a rank of two with advertisement 1024, and a rank of three with advertisement 1014.

At step 2206, the first advertisement is displayed more prominently than the second advertisement. For example, processing circuitry 306 may generate images for display screen 1000 using the procedure described above in relation to FIGS. 6A-B, such that advertisement 1024 appears closer to the viewer than advertisement 1014. Alternately, advertisement 1024 may appear in bolder colors than advertisement 1014.

If it is determined at step 2202 that the contribution related to the first advertisement is not higher than the contribution related to the second advertisement, the process proceeds to step 2208. At step 2208, it is determined whether the contribution related to the second advertisement is higher than the contribution related to the first advertisement. For example, the first advertisement may be Consumer Reports advertisement 1016, and the second advertisement may be Home Depot advertisement 1014. The contribution related to advertisement 1016 may be $500.00, and the contribution related to advertisement 1014 may be $800.00. Processing circuitry 306 may determine that the contribution related to advertisement 1014 is higher than the contribution related to advertisement 1016. If it is determined at step 2208 that the contribution related to the second advertisement is higher than the contribution related to the first advertisement, the process proceeds to step 2210.

At step 2210, the second advertisement is ranked higher than the first advertisement. For example, processing circuitry 306 may associate a rank of three with advertisement 1014, and a rank of four with advertisement 1016.

At step 2212, the second advertisement is displayed more prominently than the first advertisement. For example, processing circuitry 306 may generate images for display screen 1000 using the procedure described above in relation to FIGS. 6A-B, such that advertisement 1014 appears closer to the viewer than advertisement 1016. Alternately, advertisement 1014 may appear in bolder colors than advertisement 1016.

If it is determined at step 2208 that the contribution related to the second advertisement is not higher than the contribution related to the first advertisement, the process proceeds to step 2214. At step 2214, the first and second advertisements have the same rank. For example, the first advertisement may be associated with Consumer Reports. The second advertisement may be associated with another sponsor, Netflix. Netflix may have made a monetary contribution of $500.00, the same amount that Consumer Reports made. Processing circuitry 306 may associate an advertisement for Netflix with the same rank, four, as Consumer Reports advertisement 1016.

At step 2216, the first and second advertisements are displayed with equal prominence. For example, processing circuitry 306 may generate images for display screen 1300 such that advertisement 1016 appears at the same distance from the viewer as the Netflix advertisement.

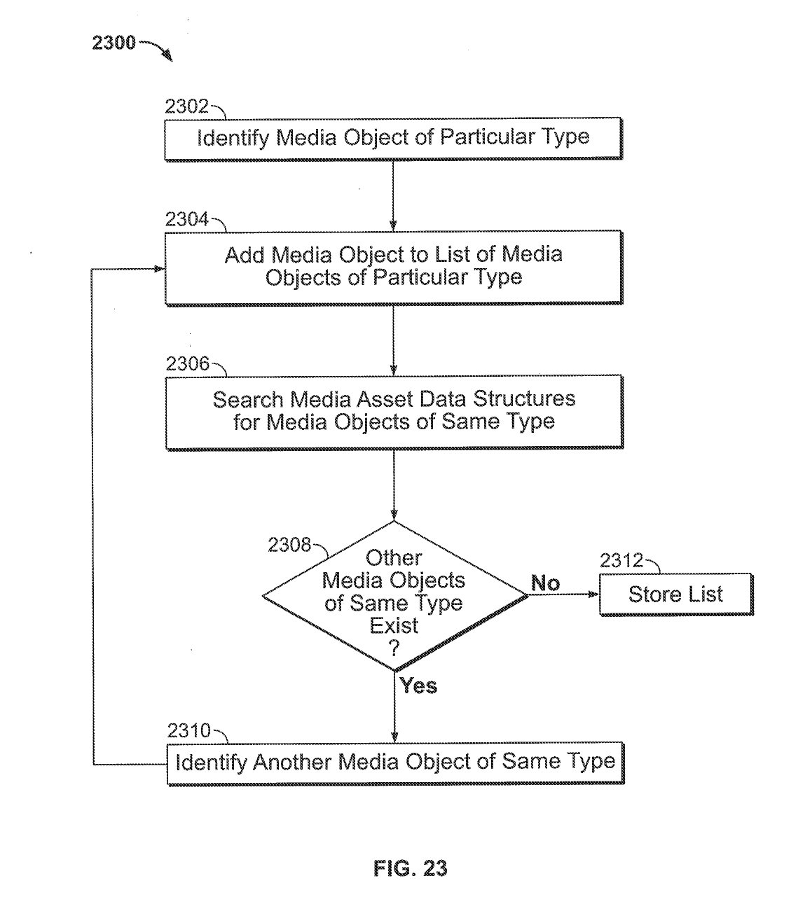

In some embodiments, each media asset may include data structures that indicate a list of media objects associated with the media asset that may be displayed. FIG. 23 is an illustrative flow diagram 2300 for creating a list of media objects of a particular type in accordance with an embodiment of the invention. At step 2302, a media object of a particular type may be identified. For example, processing circuitry 306 may identify media object 1354, discussed above in relation to FIG. 13B, as a media object associated with a videogame media asset. In particular, media object 1354, representing an avatar's home, may be identified as a “location” type of media object.

At step 2304, a media object may be added to a list of media objects of a particular type. For example, processing circuitry 306 may add media object 1354 to a list of “location”-type media objects.

At step 2306, media asset data structures may be searched for media objects of the same type. For example, processing circuitry 306 may search videogame media asset data structures for other “location”-type media objects. In another instance, processing circuitry 306 may search movie media asset data structures for “actor”-type media objects when creating a list of “actor”-type media objects.

At step 2308, it may determined whether other media objects of the same type exist. For example, it may be determined that other “location”-type media objects do exist when the search performed by processing circuitry 306 returns three results. It may be determined that other “location”-type media objects do not exist when the search performed by processing circuitry 306 returns no results. If it is determined at step 2308 that other media objects of the same type do exist, the process proceeds to step 2310.

If it is determined at step 2308 that other media objects of the same type do exist, the process proceeds to step 2310. At step 2310, another media object of the same type may be identified. For example, the search performed by processing circuitry 306 for other “location”-type media objects may return three results, one of which may be media object 1352, representing a mall. Processing circuitry 306 may identify media object 1352 as another “location”-type media object. The process then loops back to step 2304. For example, media object 1352 may be added to the list of “location”-type media objects, and the process will proceed again to step 2306.

If it is determined at step 2308 that other media objects of the same type do not exist, the process proceeds to step 2312. At step 2312, the list of media objects of the particular type may be stored. For example, the search performed by processing circuitry 306 for “location”-type media objects in step 2306 may return no “location”-type media objects that have not already been added to the list. The search result indicates that all “location”-type media objects have been added to the list, so the list may be stored, for example, in storage 308.

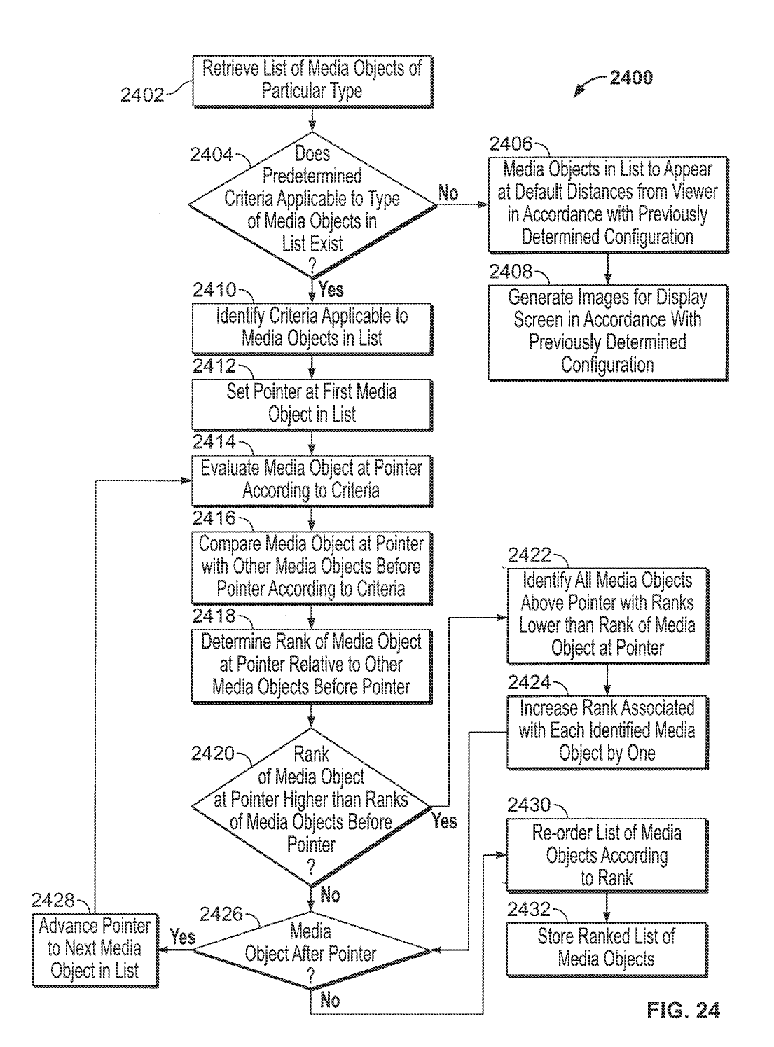

FIG. 24 is an illustrative flow diagram 2400 for creating a ranked list of media objects of a particular type in accordance with an embodiment of the invention. At step 2402, a list of media objects of a particular type may be retrieved. For example, processing circuitry 306 may retrieve a list of “location”-type media objects created by the process described above in relation to FIG. 23. In particular, the retrieved list may include “location”-type media objects in an arbitrary order.

At step 2404, it may be determined whether predetermined criteria applicable to the type of media objects in the retrieved list exist. For example, processing circuitry 306 may determine that “location”-type media objects may be evaluated according to their importance to an avatar in a videogame. Alternately, processing circuitry 306 may determine that criteria for evaluating the types of media objects in the retrieved list cannot be found or are not available, which is equivalent, from the standpoint of processing circuitry 306, to determining that such criteria do not exist. If it is determined at step 2404 that applicable predetermined criteria do not exist, the process proceeds to step 2406.

At step 2406, it may be determined that media objects in the list will appear at default distances from the viewer in accordance with a previously determined configuration. For example, processing circuitry 306 may determine that media objects with no applicable criteria will all be displayed at the same preset distance from the viewer. Alternately, processing circuitry 306 may randomly generate a distance for each media object to appear from the viewer.

At step 2408, images for a display screen in accordance with a previously determined configuration may be generated. For example, processing circuitry 306 may generate a first image for the viewer's left eye and a second image for the viewer's right eye such that when the viewer views the images using a stereoscopic optical device, the media objects will appear at the appropriate distances from the viewer.

If it is determined at step 2404 that applicable predetermined criteria do exist, the process proceeds to step 2410. At step 2410, criteria that are applicable to the media objects in the list may be identified. For example, processing circuitry 306 may identify “importance to the avatar in the current situation” as a criteria for evaluating “location”-type media objects.

At step 2412, a pointer may be set at the first media object in the list. For example, if the list includes “location”-type media objects Home, Restaurant, Salon, and Mall in that order, processing circuitry 306 may set the pointer to Home.

At step 2414, the media object at the pointer may be evaluated according to the applicable criteria. For example, processing circuitry 306 may evaluate how important going Home is to the avatar in the avatar's current situation.

At step 2416, the media object at the pointer may be compared with the other media objects before the pointer according to the criteria. For example, if the list includes media objects Home, Restaurant, Salon, and Mall in that order and the pointer is at Salon, processing circuitry 306 may evaluate the importance of Salon to the avatar relative to the importance of Home and Restaurant. If the pointer is at Home, processing circuitry 306 may determine that Home is the most important media object in the list since there are no other media objects before Home.

At step 2418, the rank of the media object at the pointer relative to the other media objects before the pointer may be determined. For example, if the pointer is at Home and Home is the first media object in the list, processing circuitry 306 may associate a rank of one with Home because there are no media objects in the list before Home. If the pointer is at Restaurant, and going to Restaurant is less important to the avatar than going to Home, processing circuitry 306 may associate a rank of two with Restaurant and keep the associated rank of one with Home.

At step 2420, it may determined whether the rank of the media object at the pointer is higher than ranks of media objects before the pointer. For example, if the pointer is at Restaurant, processing circuitry 306 may determine that Restaurant should be ranked lower than Home, so the rank of the media object at the pointer is not higher than ranks of media objects before the pointer. If the pointer is at Salon, and processing circuitry 306 has determined at step 2416 that Salon should be ranked higher than Restaurant but lower than Home, processing circuitry 306 may determine that the rank of the media object at the pointer is higher than a rank of a media object before the pointer. If it is determined at step 2420 that the rank of the media object at the pointer is not higher than any ranks of media objects before the pointer, the process proceeds directly to step 2426. If it is determined at step 2420 that the rank of the media object at the pointer is higher than ranks of media objects before the pointer, the process first proceeds to steps 2422 and 2424 before step 2426.

At step 2422, all media objects above the pointer with ranks lower than the rank of the media object at the pointer may be identified. For example, if the pointer is at Salon, processing circuitry 306 may determine that the rank of Restaurant is lower than the rank of Salon.

At step 2424, the associated rank of each media object identified above at step 2422 may be increased by one. For example, if the pointer is at Salon, the ranks of Home and Restaurant may have been one and two, respectively. However, since Salon should be ranked higher than Restaurant, processing circuitry 306 may associate a rank of two with Salon and increase the rank of Restaurant by one, so that the rank of Restaurant is now three.

At step 2426, it may be determined whether there is a media object below the pointer. For example, if the pointer is at Home, processing circuitry 306 may determine that there are media objects below the pointer, and that there are more media objects to be evaluated. If the pointer is at Mall, and Mall is the last media object in the list, processing circuitry 306 may determine that there are no media objects below the pointer, and that there are no more media objects to be evaluated. If it is determined at step 2426 that there is a media object after the pointer, the process proceeds to step 2428.

At step 2428, the pointer may be advanced to the next media object in the list. For example, if the pointer was at Home, processing circuitry 306 may move the pointer to Restaurant. After step 2428, the process loops back to 2414. For example, processing circuitry 306 may now evaluate Restaurant using the applicable criteria and follow the same procedure used on Home.

If it is determined at step 2426 that there is not a media object after the pointer, the process proceeds to step 2430. At step 2430, the list of media objects is re-ordered according to rank. For example, if Home, Restaurant, Salon, and Mall have been associated with the ranks two, four, three, and one, respectively, processing circuitry 306 may re-order the list so that the first media object is Mall, followed by Home, Salon, and Restaurant.

At step 2432, the ranked list of media objects is stored. For example, the ranked list of “location”-type media objects may be stored in storage 308.

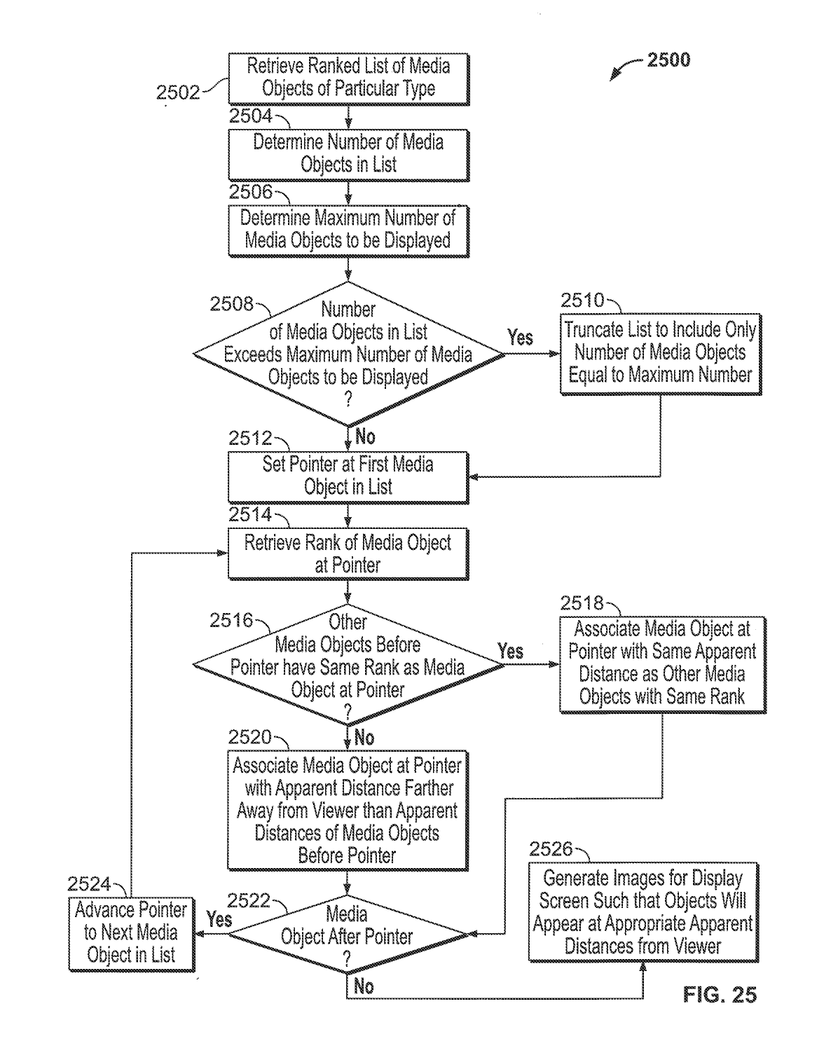

FIG. 25 is an illustrative flow diagram 2500 for associating media objects with respective apparent distances based on rank in accordance with an embodiment of the invention. At step 2502, a ranked list of media objects of a particular type may be retrieved. For example, processing circuitry 306 may retrieve a list of “location”-type media objects created by the process described above in relation to FIG. 24. In particular, the retrieved list may include “location”-type media objects Mall, Home, Salon, and Restaurant in that order.

At step 2504, the number of media objects in the retrieved ranked list may be determined. For example, processing circuitry 306 may determine that the number of media objects in the “location”-type media objects ranked list is four.

At step 2506, the maximum number of media objects to be displayed may be determined. For example, processing circuitry 306 may determine that only three media objects may be displayed.

At step 2508, it may determined whether the number of media objects in the list exceeds the maximum number of media objects to be displayed. For example, processing circuitry 306 may determine that the number of “location”-type media objects, four, exceeds the number of objects that can be displayed, three. Alternately, if up to five media objects can be displayed, processing circuitry 306 may determine that the number of “location”-type media objects does not exceed the maximum number of media objects that can be displayed. If it is determined at step 2508 that the number of media objects in the list does not exceed the maximum number of media objects to be displayed, the process proceeds directly to step 2512. If it is determined at step 2508 that the number of media objects in the list does exceed the maximum number of media objects to be displayed, the process first proceeds to step 2510 before step 2512.

At step 2510, the list may be truncated to include only the number of media objects equal to the maximum number of media objects to be displayed. For example, processing circuitry 306 may eliminate the lowest-ranked media objects from the list, leaving only the number of highest-ranked media objects equal to the maximum number that can be displayed. In particular, processing circuitry 306 may truncate a “location”-type media object ranked list to include only Mall, Home, and Salon.

At step 2512, the pointer may be set to the first media object in the list. For example, if the ranked list contains the “location”-type media objects Mall, Home, Salon, and Restaurant in that order, processing circuitry 306 may set the pointer to Mall.

At step 2514, the rank of the media object at the pointer may be retrieved. For example, if the pointer is at Mall, processing circuitry 306 may retrieve the rank of one from storage 308.

At step 2516, it may determined whether other media objects before the pointer have the same rank as the media object at the pointer. For example, if the pointer is at Home, processing circuitry 306 may retrieve the rank of one associated with Home and determine that Home has the same rank as Mall. If the pointer is at Salon, processing circuitry may determine that no other media objects before Salon have the same associated rank as Salon, two. If it is determined at step 2516 that other media objects before the pointer do have the same rank as the media object at the pointer, the process proceeds to step 2518 before step 2522. If it is determined at step 2516 that other media objects before the pointer do not have the same rank as the media object at the pointer, the process proceeds to step 2520 before step 2522.

At step 2518, the media object at the pointer may be associated with the same apparent distance as other media objects with the same rank. For example, if the pointer is at Home, and both Mall and Home have an associated rank of one, processing circuitry 306 may determine that Home should be associated with the same apparent distance as Mall. In particular, Mall and Home should appear at the same distance from the viewer in a stereoscopic videogame environment display.

At step 2520, the media object at the pointer may be associated with an apparent distance farther away from the viewer than the apparent distances of media objects before the pointer. For example, if the pointer is at Salon, no other media objects before Salon have the same rank as Salon, so processing circuitry 306 may associate Salon with an apparent distance farther away from the viewer than the apparent distance associated with Mall and Home. In particular, Salon should appear farther away from the viewer than Mall and Home in a stereoscopic videogame environment display.

At step 2522, it may be determined whether there is a media object below the pointer. For example, if the pointer is at Home, processing circuitry 306 may determine that there are media objects below the pointer, and that there are more media objects to be associated with respective apparent distances. If the list has been truncated to three media objects and the pointer is at Salon, processing circuitry 306 may determine that there are no media objects below the pointer, and that all media objects in the list have respective associated apparent distances. If it is determined at step 2522 that there is a media object after the pointer, the process proceeds to step 2524.

At step 2524, the pointer may be advanced to the next media object in the list. For example, if the pointer was at Home, processing circuitry 306 may move the pointer to Salon. After step 2524, the process loops back to 2514. For example, processing circuitry 306 may now follow the same procedure used on Home to associate a suitable apparent distance with Salon.

If it is determined at step 2522 that there is not a media object after the pointer, the process proceeds to step 2526. At step 2526, images for a display screen may be generated such that media objects will appear at appropriate apparent distances from the viewer. For example, processing circuitry 306 may generate a first image for the viewer's left eye and a second image for the viewer's right eye such that when the viewer views the images using a stereoscopic optical device, the Mall and Home will appear at the same distance from the viewer, and Salon will appear farther away from the viewer than Mall and Home.

It should be understood that the above steps of the flow diagram of FIGS. 21-25 may be executed or performed in any order or sequence not limited to the order and sequence shown and described in the figure. Also, some of the above steps of the flow diagrams of FIGS. 21-25 may be executed or performed substantially simultaneously where appropriate or in parallel to reduce latency and processing times.

The above described embodiments of the present invention are presented for purposes of illustration and not of limitation, and the present invention is limited only by the claims which follow.

1. A method for displaying media objects in a stereoscopic media environment to a viewer according to media object ranks, the method comprising:
identifying first and second media objects to be displayed;
determining, based on predetermined criteria, that the first media object is to be displayed more prominently in three-dimensional space than the second media object, wherein the determining allows a first rank to be associated with the first media object and a second rank lower than the first rank to be associated with the second media object; and
associating the first and second media objects with respective first and second distances corresponding to the respective first and second ranks, such that when the first and second media objects are viewed using a stereoscopic optical device, the first and second media objects are perceived to appear at the respective first and second distances in three-dimensional space, wherein the first distance is perceived by the viewer to be closer to the viewer than the second distance.

2. The method of claim 1, further comprising:
displaying the first media object using a user equipment device with a display screen, wherein:
the first media object appears in a first plane when viewed using the stereoscopic optical device; and
the first plane is perceived to intersect an axis normal to the display screen at a first location at the first distance from the viewer; and
displaying the second media object using the user equipment device, wherein:
the second media object appears in a second plane when viewed using the stereoscopic optical device; and
the second plane is perceived to intersect the axis at a second location at the second distance, wherein the second distance is farther from the viewer than the first distance.

3. The method of claim 1, wherein the first and second media objects are selectable media objects.

4. The method of claim 3, further comprising:
receiving a viewer selection of at least one of the first and second media objects; and
displaying additional information about the at least one selected media object.

5. The method of claim 1, wherein the first media object appears more prominent in the stereoscopic media environment than the second media object.

6. The method of claim 1, further comprising visually distinguishing the first media object from other media objects.

7. The method of claim 6, wherein the visually distinguishing comprises a technique selected from the group consisting of blinking the first media object repeatedly, displaying the first media object in a highlight region, displaying a border around the first media object, displaying a flashing background behind the first media object, displaying the first media object in more vivid colors than other media objects, displaying bold text in the first media object, animating the first media object, and displaying a message directing the viewer's attention to the first media object.

8. The method of claim 1, wherein the stereoscopic media environment is a stereoscopic media guidance application.

9. The method of claim 8, wherein the first and second media objects comprise respective first and second media listings.

10. The method of claim 9, wherein the media listings represent a plurality of media assets selected from the group consisting of television shows, movies, pay-per-view programs, on-demand programs, music videos, songs, items for purchase, internet websites, advertisements, shopping applications, and videogames.

11. The method of claim 9, wherein the first and second media listings are recommendations of respective first and second media assets based on a criterion selected from the group consisting of compatibility with a viewer profile, praise from a consumer advocacy group, and popularity among other viewers.

12. The method of claim 11, wherein the first and second ranks are related to how well the first and second media assets meet the selected criterion.

13. The method of claim 1, wherein the stereoscopic media environment is a videogame environment.

14. The method of claim 13, wherein:
the first and second media objects are respective first and second collectible objects for an avatar;
the first and second ranks are related to how important the first and second collectible objects are to the avatar; and
the collectible objects are selected from the group consisting of ammunition, tools, special ability, health, food, currency, clothing, accessories, and extra life.

15. The method of claim 13, wherein:
the first and second media objects comprise respective first and second locations to which an avatar should navigate; and
the first and second ranks are related to how important the first and second locations are to the avatar.

16. The method of claim 13, wherein:
the first and second media objects comprise a first and second warning; and
the first and second ranks are related to how urgent the first and second warnings are.

17. The method of claim 1, wherein the stereoscopic media environment includes a scene from a media asset, wherein the media asset is selected from the group consisting of television shows, movies, pay-per-view programs, on-demand programs, music videos, internet websites, advertisements, shopping applications, and videogames.

18. The method of claim 17, wherein:
the first media object appears in the scene as a first scene object related to a first monetary contribution from a first sponsor;
the second media object appears in the scene as a second scene object related to a second monetary contribution from a second sponsor; and
the first and second ranks are related to the amounts of the first and second monetary contributions.

19. The method of claim 1, wherein the stereoscopic media environment is selected from one of a chat room, an electronic mail client, and a survey.

20. The method of claim 19, wherein:
the first and second media objects comprise respective first and second messages for the viewer; and
the first and second ranks relate to how high of a priority the first and second messages are for the viewer.

21. The method of claim 19, wherein the first and second media objects comprise regions for viewer input.

22. The method of claim 19, wherein:
the first and second media objects comprise respective first and second icons; and
the first and second ranks relate to how useful the first and second icons are for the viewer.

23. The method of claim 1, further comprising displaying text in the stereoscopic media environment.

24. The method of claim 23, wherein:
the first and second media objects comprise respective first and second images related to the displayed text; and
the first and second ranks relate to how relevant the first and second images are to the displayed text.

25. The method of claim 23, wherein:
the first and second media objects comprise displayed text; and
the first and second ranks relate to how prominent the displayed text in the first and second media objects appears.

26. The method of claim 1, wherein:
the first and second media objects comprise respective first and second instructions for navigating within the stereoscopic media environment; and
the first and second rank relate to how useful the first and second instructions are to the viewer.

27. The method of claim 1, wherein the stereoscopic media environment comprises credits for a media asset, wherein the media asset is selected from the group consisting of television shows, movies, pay-per-view programs, on-demand programs, music videos, songs, internet websites, advertisements, shopping applications, and videogames.

28. The method of claim 27, wherein:
the first and second media objects comprise respective first and second names; and
the first and second ranks relate to how important the first and second names are to the media asset.

29. The method of claim 1, wherein:
the first and second media objects are respective first and second reminders related to a media asset; and
the first and second ranks relate to how urgent the first and second reminders are.

30. A method for displaying advertisements in a stereoscopic media environment to a viewer according to media object ranks, the method comprising:
identifying first and second advertisements to be displayed;
determining, based on predetermined criteria, that the first advertisement is to be displayed more prominently in three-dimensional space than the second advertisement, wherein the determining allows a first rank to be associated with the first advertisement and a second rank lower than the first rank to be associated with the second advertisement;
displaying the first advertisement using a user equipment device with a display screen, wherein:
the first advertisement is perceived to appear in a first plane when viewed using a stereoscopic optical device;
the first plane intersects an axis normal to the display screen at a first location; and
the first location is at a first distance from the viewer, the first distance corresponding to the first rank; and
displaying the second advertisement using the user equipment device, wherein:
the second advertisement is perceived to appear in a second plane when viewed using the stereoscopic optical device;
the second plane intersects the axis at a second location that is at a second distance corresponding to the second rank; and
the first distance is perceived by the viewer to be closer to the viewer than the second distance.

31. The method of claim 30, wherein the first and second advertisements are selectable.

32. The method of claim 31, further comprising:
receiving a viewer selection of at least one of the first and second advertisements; and
displaying additional information about the at least one selected advertisement.

33. The method of claim 30, wherein the first and second advertisements correspond to a first sponsor.

34. The method of claim 33, wherein the first and second ranks are related to respective contributions received from the first sponsor for the first and second advertisements.

35. The method of claim 30, wherein the first advertisement corresponds to a first sponsor and the second advertisement corresponds to a second sponsor different from the first sponsor.

36. The method of claim 35, wherein:
the first rank is related to a first monetary contribution received from the first sponsor; and
the second rank is related to a second monetary contribution received from the second sponsor.

37. The method of claim 30, wherein the stereoscopic media environment is a stereoscopic media guidance application.

38. The method of claim 30, wherein the first advertisement appears more prominent in the stereoscopic media environment than the second advertisement.

39. A system for displaying media objects in a stereoscopic media environment to a viewer according to media object ranks, the system comprising processing circuitry configured to:
identify first and second media objects to be displayed;
determine, based on predetermined criteria, that the first media object is to be displayed more prominently in three-dimensional space than the second media object, wherein the determination allows a first rank to be associated with the first media object and a second rank lower than the first rank to be associated with the second media object; and
associate the first and second media objects with respective first and second distances corresponding to the respective first and second ranks, such that when the first and second media objects are viewed using a stereoscopic optical device, the first and second media objects are perceived to appear at the respective first and second distances in three-dimensional space, wherein the first distance is perceived by the viewer to be closer to the viewer than the second distance.

40. The system of claim 39, further comprising:
a display screen having a normal axis; and
wherein the processing circuitry is further configured to:
display, on the display screen, the first media object, wherein:
the first media object appears in a first plane when viewed using the stereoscopic optical device; and
the first plane is perceived to intersect the axis at a first location at the first distance from the viewer; and
display, on the display screen, the second media object, wherein:
the second media object appears in a second plane when viewed using the stereoscopic optical device; and
the second plane is perceived to intersect the axis at a second location at the second distance, wherein the second distance is farther from the viewer than the first distance.

41. The system of claim 39, wherein the first and second media objects are selectable media objects.

42. The system of claim 41, wherein the processing circuitry is further configured to:
receive a viewer selection of at least one of the first and second media objects; and
display additional information about the at least one selected media object.

43. The system of claim 39, wherein the first media object appears more prominent in the stereoscopic media environment than the second media object.

44. The system of claim 39, wherein the processing circuitry is further configured to visually distinguish the first media object from other media objects.

45. The system of claim 44, wherein the visually distinguishing comprises a technique selected from the group consisting of blinking the first media object repeatedly, displaying the first media object in a highlight region, displaying a border around the first media object, displaying a flashing background behind the first media object, displaying the first media object in more vivid colors than other media objects, displaying bold text in the first media object, animating the first media object, and displaying a message directing the viewer's attention to the first media object.

46. The system of claim 39, wherein the stereoscopic media environment is a stereoscopic media guidance application.

47. The system of claim 46, wherein the first and second media objects comprise respective first and second media listings.

48. The system of claim 47, wherein the media listings represent a plurality of media assets selected from the group consisting of television shows, movies, pay-per-view programs, on-demand programs, music videos, songs, items for purchase, internet websites, advertisements, shopping applications, and videogames.

49. The system of claim 47, wherein the first and second media listings are recommendations of respective first and second media assets based on a criterion selected from the group consisting of compatibility with a viewer profile, praise from a consumer advocacy group, and popularity among other viewers.

50. The system of claim 49, wherein the first and second ranks are related to how well the first and second media assets meet the selected criterion.

51. The system of claim 39, wherein the stereoscopic media environment is a videogame environment.

52. The system of claim 51, wherein:
the first and second media objects are respective first and second collectible objects for an avatar;
the first and second ranks are related to how important the first and second collectible objects are to the avatar; and
the collectible objects are selected from the group consisting of ammunition, tools, special ability, health, food, currency, clothing, accessories, and extra life.

53. The system of claim 51, wherein:
the first and second media objects comprise respective first and second locations to which an avatar should navigate; and
the first and second ranks are related to how important the first and second locations are to the avatar.

54. The system of claim 51, wherein:
the first and second media objects comprise a first and second warning; and
the first and second ranks are related to how urgent the first and second warnings are.

55. The system of claim 39, wherein the stereoscopic media environment includes a scene from a media asset, wherein the media asset is selected from the group consisting of television shows, movies, pay-per-view programs, on-demand programs, music videos, internet websites, advertisements, shopping applications, and videogames.

56. The system of claim 55, wherein:
the first media object appears in the scene as a first scene object related to a first monetary contribution from a first sponsor;
the second media object appears in the scene as a second scene object related to a second monetary contribution from a second sponsor; and
the first and second ranks are related to the amounts of the first and second monetary contributions.

57. The system of claim 39, wherein the stereoscopic media environment is selected from one of a chat room, an electronic mail client, and a survey.

58. The system of claim 57, wherein:
the first and second media objects comprise respective first and second messages for the viewer; and
the first and second ranks relate to how high of a priority the first and second messages are for the viewer.

59. The system of claim 57, wherein the first and second media objects comprise regions for viewer input.

60. The system of claim 57, wherein:
the first and second media objects comprise respective first and second icons; and
the first and second ranks relate to how useful the first and second icons are for the viewer.

61. The system of claim 39, wherein the processing circuitry is further configured to display text in the stereoscopic media environment.

62. The system of claim 61, wherein:
the first and second media objects comprise respective first and second images related to the displayed text; and
the first and second ranks relate to how relevant the first and second images are to the displayed text.

63. The system of claim 61, wherein:
the first and second media objects comprise displayed text; and
the first and second ranks relate to how prominent the displayed text in the first and second media objects appears.

64. The system of claim 39, wherein:
the first and second media objects comprise respective first and second instructions for navigating within the stereoscopic media environment; and
the first and second rank relate to how useful the first and second instructions are to the viewer.

65. The system of claim 39, wherein the stereoscopic media environment comprises credits for a media asset, wherein the media asset is selected from the group consisting of television shows, movies, pay-per-view programs, on-demand programs, music videos, songs, internet websites, advertisements, shopping applications, and videogames.

66. The system of claim 65, wherein:
the first and second media objects comprise respective first and second names; and
the first and second ranks relate to how important the first and second names are to the media asset.

67. The system of claim 39, wherein:
the first and second media objects are respective first and second reminders related to a media asset; and
the first and second ranks relate to how urgent the first and second reminders are.

68. A system for displaying advertisements in a stereoscopic media environment to a viewer according to media object ranks, the system comprising:
a display screen having a normal axis; and
processing circuitry configured to:
identify first and second advertisements to be displayed;
determine, based on predetermined criteria, that the first advertisement is to be displayed more prominently in three-dimensional space than the second advertisement, wherein the determination allows a first rank to be associated with the first advertisement and a second rank lower than the first rank to be associated with the second advertisement;
display the first advertisement, wherein:
the first advertisement is perceived to appear in a first plane when viewed using a stereoscopic optical device;
the first plane intersects the axis at a first location; and
the first location is at a first distance from the viewer, the first distance corresponding to the first rank; and
display the second advertisement using the user equipment device, wherein:
the second advertisement is perceived to appear in a second plane when viewed using the stereoscopic optical device;
the second plane intersects the axis at a second location that is at a second distance corresponding to the second rank; and
the first distance is perceived by the viewer to be closer to the viewer than the second distance.

69. The system of claim 68, wherein the first and second advertisements are selectable.

70. The system of claim 69, wherein the processing circuitry is further configured to:
receive a viewer selection of at least one of the first and second advertisements; and
display additional information about the at least one selected advertisement.

71. The system of claim 68, wherein the first and second advertisements correspond to a first sponsor.

72. The system of claim 71, wherein the first and second ranks are related to respective contributions received from the first sponsor for the first and second advertisements.

73. The system of claim 68, wherein the first advertisement corresponds to a first sponsor and the second advertisement corresponds to a second sponsor different from the first sponsor.

74. The system of claim 73, wherein:
the first rank is related to a first monetary contribution received from the first sponsor; and
the second rank is related to a second monetary contribution received from the second sponsor.

75. The system of claim 68, wherein the stereoscopic media environment is a stereoscopic media guidance application.

76. The system of claim 68, wherein the first advertisement appears more prominent in the stereoscopic media environment than the second advertisement.

77-114. (canceled)
